(19) United States
(12) Patent Application Publication
(10) Pub. No.: US 2013/0155362 A1
(43) Pub. Date: Jun. 20, 2013

(54) LIQUID CRYSTAL DISPLAY PANEL, LIQUID CRYSTAL DISPLAY DEVICE, AND POLYMER FOR ALIGNMENT FILM MATERIAL

(71) Applicants: Shinichi Terashita, Osaka-shi (JP); Yuko Teraoka, Osaka-shi (JP); Kouichi Matsuhashi, Osaka-shi (JP); Akihito Jinda, Osaka-shi (JP)

(72) Inventors: Shinichi Terashita, Osaka-shi (JP); Yuko Teraoka, Osaka-shi (JP); Kouichi Matsuhashi, Osaka-shi (JP); Akihito Jinda, Osaka-shi (JP)

(73) Assignee: SHARP KABUSHIKI KAISHA, Osaka-shi, Osaka (JP)

(21) Appl. No.: 13/819,883

(22) PCT Filed: Aug. 23, 2011
(86) PCT No.: PCT/JP2011/068940

§ 371 Date: Feb. 28, 2013

(30) Foreign Application Priority Data
Aug. 30, 2010 (JP) 2010-192954

(51) Int. Cl. G02F 1/1337

(52) U.S. Cl. CPC G02F 1/133711
USPC 349/123

(57) ABSTRACT

In a photo-alignment liquid crystal panel capable of achieving a uniform display quality and highly reliable photo-alignment properties, and excellent electro-optical properties (transmittance, contrast, viewing angle, and response) for improving a basic performance and a high image quality of a liquid crystal panel and a liquid crystal display device, a structural composition of a polymer, which is preferable as a photo-alignment film, is unclear. The invention optimizes a copolymerization ratio and a modification rate of a photopolymer in order for a compound having photo-alignment properties to be contained as the photo-alignment film so as to enable the photo-alignment film to have the photo-alignment properties, and achieves the discovery of a preferred structural composition of the polymer. An object of the invention is to efficiently produce and provide a display panel and a liquid crystal display device that have excellent electrical properties and optical properties, and have a sufficient liquid crystal display quality and reliability.

### TECHNICAL FIELD

The present invention relates to a liquid crystal display panel, a liquid crystal display device, and a polymer for an alignment film material. More particularly, the invention relates to a liquid crystal display device that has wide viewing angle characteristics and that is very suitable for a planar display of a personal digital assistant, a personal computer, a word processor, amusement equipment, a teaching machine, and a TV device, and the like that are used by many people, a display board, a display window, a display door, and a display wall, and the like, each utilizing a shutter effect of liquid crystal, a liquid crystal display panel that is used thereto, and a polymer for an alignment film material.

### BACKGROUND ART

A liquid crystal display device is now being widely used due to its characteristics such as slim profile, light weight, and low electrical power consumption. The liquid crystal display device includes a pair of substrates that interpose a liquid crystal layer therebetween. The liquid crystal device provides liquid crystal display by controlling an alignment direction of liquid crystal molecules contained in the liquid crystal layer by appropriately applying a voltage to electrodes provided on the substrates on a liquid crystal layer side. In addition, commonly, the liquid crystal display device includes an alignment film that is provided on a surface of the substrate on the liquid crystal layer side to control an alignment direction of the liquid crystal molecules.

As a material of the alignment film constituting the liquid crystal display device, resins such as polyamic acid, polyimide, polyamide, polysiloxane, and polyester (including a derivative thereof, respectively) are conventionally used. Among these, polyimide exhibits physical properties in which heat resistance, affinity with liquid crystal, mechanical strength, and the like are excellent in an organic resin, and thus has been used in various liquid crystal display devices.

In addition, the alignment film is generally subjected to an alignment treatment to apply a constant pretilt angle to the liquid crystal molecules on the surface of the alignment film. Examples of a method of the alignment treatment include a rubbing method, a photo-alignment method, and the like. In the rubbing method, the alignment treatment is carried out by rubbing the surface of the alignment film with cloth wound on a roller. On the other hand, the photo-alignment method is an alignment method in which a photo-alignment film is used as an alignment film material, and the photo-alignment film is irradiated with (exposed to) light such as ultraviolet ray, whereby an alignment regulation force is caused to occur in the alignment film, and/or an alignment regulation direction of the alignment film is caused to vary.

However, in the liquid crystal display device including the alignment film in the related art, image-sticking may occur on a screen by lightening for a long period of time, and thus there is a room for improvement from the viewpoint of suppressing the occurrence of the image-sticking even after lightening for a long period of time.

Conversely, as a technology of providing a liquid crystal aligning agent capable of forming a liquid crystal alignment film which prevents display defects, has an excellent after-image characteristic even after long-time driving, does not decrease the capability of aligning liquid crystal, and in which a decrease in voltage holding ratio against light and heat is small, there is disclosed a liquid crystal aligning agent composition containing a tetrafunctional silicon compound such as tetraalkoxy silane, a trifunctional compound such as trialkoxy silane, and a product of reaction with 0.8 to 3.0 moles of water for 1 mole of a functional group such as an alkoxy group, and a glycol ether-based solvent (for example, refer to Patent Document 1).

In addition, as a technology of providing a liquid crystal aligning agent capable of forming a liquid crystal alignment film which may exhibit satisfactory coating film formability and liquid crystal alignment characteristics, and may form a liquid crystal alignment film capable of deleting after-images in a short time after the stop of application of a voltage in a liquid crystal display device, there is provided a liquid crystal aligning agent including polyamic acid having a structure derived from a monoamine compound, or an imidized polymer thereof (for example, refer to Patent Document 2).

In addition, as a technology of providing a liquid crystal aligning agent that provides a vertical liquid crystal alignment film excellent in image-sticking characteristics and reliability even when used with a reflecting electrode, there is disclosed a vertical liquid crystal aligning agent which includes 100 parts by weight of a polymer having an amic acid repeating unit and/or an imide repeating unit, and at least 5 parts by weight of a compound having at least two epoxy groups in a molecule (for example, refer to Patent Document 3).

Furthermore, in a document related to the photo-alignment film, it is reported that the smaller electrical resistivity of the photo-alignment film is, the shorter an image-sticking time (for example, refer to Non-Patent Document 1).

In addition, in a document related to material development of the alignment film, it is reported that with regard to a vertical electric field liquid crystal cell, image-sticking may be reduced by decreasing residual DC (for example, refer to Non-Patent Document 2).

In addition, in an AC-driving liquid crystal display device, the residual DC is generated by voltage deviation of an offset voltage between electrodes formed on substrates opposite to each other.

On the other hand, with regard to a photo-reactive polymer that manufactures a stable high-resolution alignment pattern having a defined inclination angle when being irradiated with polarized light, and having a sufficiently high resistance value (holding rate) for an adjacent liquid crystal medium, there is disclosed polyimide including a side chain group that may be structurally derived from 3-aryl acrylic acid (for example, refer to Patent Document 4).

In addition, with regard to a photo-reactive polymer that generates a stable high-resolution alignment pattern having a very large tilt angle when being irradiated with polarized light, and causes a sufficiently high holding rate in an adjacent liquid crystal medium, there is disclosed polyimide including a cinnamic acid group derivative in such a manner that the cinnamic acid group is coupled to a polyimide main chain through a carboxyl group by a flexible spacer (for example, refer to Patent Document 5).

Furthermore, there is disclosed a functionalized photo-reactive compound which is used for a liquid crystal alignment material and in which a specific electron-attracting group is added to a specific molecular structure having unsaturation that is directly coupled to two unsaturated ring structures (for example, refer to Patent Document 6).

In addition, as a photo-cross-linked material, specific diamine compounds, and a polymer, a copolymer, polyamic acid, polyamic acid ester, or polyimide that are based on the compounds are suggested (for example, refer to Patent Document 7).

### CITATION LIST

### Patent Document

[Patent Document 1] Japanese Unexamined Patent Application Publication No. 2005-250244
[Patent Document 2] Japanese Unexamined Patent Application Publication No. 2006-52317
[Patent Document 3] Japanese Unexamined Patent Application Publication No. 2006-10896
[Patent Document 4] Japanese Unexamined Patent Application Publication (Translation of PCT Application) No. 2001-517719
[Patent Document 5] Japanese Unexamined Patent Application Publication (Translation of PCT Application) No. 2003-520878
[Patent Document 6] Japanese Unexamined Patent Application Publication (Translation of PCT application) No. 2009-511431
[Patent Document 7] Japanese Unexamined Patent
Application Publication (Translation of PCT application) No. 2009-520702

### Non-Patent Document

[Non-Patent Document 1] Masaki Hasegawa, “Photo-alignment-Alignment Treatment from the Viewpoint of the Manufacturing Process”, Liquid Crystal, Journal of the Japanese Liquid Crystal Society 3(1), p. 3-16, Jan. 25, 1999.
[Non-Patent Document 2] Kiyoshi Sawahata “Material Development Trend of Alignment Film for LCD”, Liquid Crystal, Journal of the Japanese Liquid Crystal Society 8(4), p. 216-224, Oct. 25, 2004.

### DISCLOSURE OF INVENTION

### Problems to be Solved by the Invention

However, in a photo-alignment liquid crystal panel capable of achieving a uniform display quality and highly reliable photo-alignment properties, and excellent electro-optical properties (transmittance, contrast, viewing angle, and response) for improving a basic performance and a high image quality of a liquid crystal panel and a liquid crystal display device, a structural composition of a polymer, which is preferable as a photo-alignment film, is unclear.

In addition, with regard to a resin (polymer) that is an alignment film included in the liquid crystal panel, and a constituent material thereof, in a case of a new chemical material, when manufacturing a liquid crystal panel, it is necessary to suppress a used amount thereof as much as possible so as to reduce load on the environment.

Particularly, in the alignment film, due to mixing with a different kind of polymer, a problem of precipitation to an ink solvent may be caused, uniformity of the liquid crystal alignment may decrease, and electrical properties such as a voltage holding ratio or residual DC that becomes a cause of image-sticking may deteriorate. As a result, the mixing may become a cause of a decrease in display qualities and reliability.

In the vertical photo-alignment film of the Patent Documents 5 and 6, not only image-sticking of a strong residual DC mode but also image-sticking (AC memory (ACM)) of an AC mode due to a variation in a pretilt angle during application of an AC voltage occur concurrently, and thus it is necessary to solve these at the same time.

In addition, in a photo-alignment film (homopolymer) having a photo-functional group capable of applying a pretilt angle to a liquid crystal molecule by causing a photo-chemical reaction (photo-cross-linking reaction (including a photo-dimerization reaction), a photo-isomerization reaction, and a photo-decomposition reaction) to occur, even when a molecular structure of a material having the photo-functional group is similar, there is a difference in the image-sticking (ACM) due to the application of the AC voltage in a specific level.

Furthermore, a photo-alignment film material, which is capable of having the photo-alignment properties when a compound having the photo-alignment properties is added thereto, is preferable.

In addition, in a liquid crystal display device such as a TN (Twisted Nematic) mode, an ECB (Electrically Controlled Birefringence) mode, and a VATN (Vertical Alignment Twisted Nematic) mode to which one-directional liquid crystal alignment treatment is performed in a substrate surface, viewing angle dependency is present. Therefore, a direction in which an image-sticking phenomenon may be observed depends on viewing angle characteristics of the liquid crystal alignment mode in addition to the front direction. On the other hand, in a liquid crystal TV or a large screen display for information, alignment division of liquid crystal is made for viewing angle compensation during white display. In this manner, in a viewing angle-compensated alignment division mode, since the image-sticking phenomenon uniformly appears in all directions, it is necessary to improve the image-sticking phenomenon. In addition, the VATN mode may be a mode called an RTN (Reverse Twisted TN; TN of vertical alignment). The ECB mode may be any one of a type (VAECB) having vertical alignment during not-application of a voltage and horizontal alignment during application of a voltage, and a type having horizontal alignment during not-application of a voltage and vertical alignment during application of a voltage.

The invention has been made in consideration of the above-described situations, and an object thereof is to effectively produce and provide a display panel and a liquid crystal display device that have excellent electrical properties and optical properties, and having a uniform display quality and sufficient reliability.

### Means for Solving the Problems

Examples of a method of preparing the alignment film in the liquid crystal display panel include a method in which a layer formed from another polymer is formed on a substrate to apply functionality to the alignment film. Examples of a method of forming the alignment film include methods called a modification treatment, two-layer treatment, and hybridization. For example, a polymer of a horizontal alignment film and a polymer of a vertical alignment film, or a fluorine not-introduced polymer and a fluorine-introduced polymer are blended, for example, a vertical alignment film not having photo-alignment properties as the fluorine not-introduced polymer and a vertical alignment film having photo-alignment properties as the fluorine-introduced polymer are blended in a constant solid-content weight ratio (for example, 30:70 to 5:95), and the horizontal alignment film is formed on a substrate side and the vertical alignment film is formed on a liquid crystal side due to an operation in which phase separation between polymers occurs immediately after application onto the substrate or during a baking process after the application of the alignment film. Due to this operation, a volume of the alignment film that is exposed to the liquid crystal side (a volume of the vertical alignment film formed on the liquid crystal side) may be reduced, and thus an alignment film material (for example, an alignment film material that is a new chemical material, and/or an alignment film material having a photo-functional group) may be contained only in an amount of the alignment film that is exposed to the liquid crystal layer side. Accordingly, a used amount of the alignment film material may be reduced. Since the residual DC, which becomes a cause of the image-sticking, may be reduced while maintaining a film thickness of the alignment film, the above-described treatment may be performed if necessary. The modification rate of the invention represents a weight ratio (weight % (wt %)) of a solid content of the non-photo-alignment polymer with the weight of total solid contents of the photo-alignment polymer and the non-photo-alignment polymer set to 100%. For example, when the modification rate is 70 weight % or less, although depending on a variation in manufacturing conditions of the liquid crystal panel and reliability test conditions, stain irregularity or image-sticking caused by the residual DC may occur by high-temperature electrical conduction aging. Therefore, a configuration having a relatively higher modification rate is preferable. However, even in the photo-alignment film in an amount sufficient for covering a surface area on a liquid crystal side, in a case of too higher modification rate, since exposure of the photo-alignment film to a liquid crystal side is not sufficient, a modification treatment material is present on a surface on a liquid crystal side, and thus AC image-sticking may get worse. Therefore, a modification rate, which is capable of solving the residual DC image-sticking and the AC image-sticking at the same time, is preferable.

In addition, when a chemical material capable of preventing liquid-crystal adsorption, or side-chain deformation is introduced, suppression of the AC image-sticking may be expected. Furthermore, an improvement in printing coating properties of spin coating, flexographic printing, inkjet, and the like may be expected.

Until now, in a homopolymer using only a photo-alignment diamine unit, and in a copolymerization in which an introduction ratio of a photo-alignment diamine unit and a non-photo-alignment diamine unit is 4 mol % or less (the total diamine units are set to 100 mol %) (or when a total unit compositional ratio is set to 100%, a unit is %. In other words, a unit of an introduction ratio of a monomer component may be expressed by mol %, but may be expressed by % as a compositional ratio of a constituent unit), although depending on a variation in manufacturing conditions of the liquid crystal display panel, alignment irregularity caused by the liquid crystal tilt may significantly occur due to high-temperature electrical conduction aging, and thus there are problems of a display quality and reliability. When a non-photo-alignment diamine unit is introduced, there is a tendency for the above-described problems to be reduced. Furthermore, in a polymerization in which the introduction ratio of the photo-alignment diamine unit and the non-photo-alignment diamine unit is high, due to a decrease in density of the photo-functional group, there is a concern that photo-sensitivity decreases, a photo-irradiation time becomes long, and display properties such as transmittance and response properties deteriorate. According to the invention, plural kinds of photo-alignment film materials, in which electrical properties and optical properties are made equal to each other, may be provided.

The present inventors made an investigation on a polymer for an alignment film material, which contains a compound having photo-alignment properties and thus may have photo-alignment properties, and which is excellent in a display quality, reliability, and display properties, and a liquid crystal panel and a liquid crystal display device using the same. In addition, the present inventors made various investigations on respective structures contained in an alignment film, and polymers for an alignment film material, and they paid attention to a molecular structure and a composition of a main chain and a side chain.

The present inventors optimized a polymer copolymerization ratio in order for a compound having photo-alignment properties to be contained so as to have photo-alignment properties, and found a range of a used amount with which electro-optical properties are not problematic. Furthermore, they also carried out optimization about a modification rate, and found that a range with which the electro-optical properties are excellent. In addition, they found a structural composition of a polymer that is preferable as a photo-alignment film and is excellent in the electro-optical properties. According to this, they assumed that the above-described problems in the invention may be solved, and they accomplished the invention.

That is, according to an aspect of the invention, there is provided a liquid crystal display panel (also, referred to as a first invention) that has a configuration in which a liquid crystal layer containing liquid crystal molecules is interposed between a pair of substrates, and includes a photo-alignment film on a surface of at least one substrate on a liquid crystal layer side. In the photo-alignment film, a film formed using an alignment film material containing a polymer is subjected to an alignment treatment by photo-irradiation, the polymer including a first constituent unit exhibiting a property of controlling alignment of the liquid crystal molecules by photo-irradiation and a second constituent unit exhibiting a property of controlling alignment of the liquid crystal molecules without photo-irradiation as essential constituent units. The first constituent unit exhibits the property of controlling alignment of the liquid crystal molecules by at least one photo-chemical reaction selected from a photo-cross-linking reaction and a photo-isomerization reaction. An introduction ratio of a second constituent unit exceeds 4 mol % and is equal to or less than 10 mol % on the basis of 100 mol % of a total of the first constituent unit and the second constituent unit.

The second constituent unit is a constituent unit (a monomer unit) in the polymer, which exhibits the property of performing the alignment control of the liquid crystal molecules without the photo-irradiation. However, the second constituent unit may be a unit that exhibits the property of performing the alignment control of the liquid crystal molecules in a technology of controlling the alignment of the liquid crystal molecules, and that is evaluated as one exhibiting the properties according to a method other than the photo-irradiation. It is preferable that the introduction ratio of the second constituent unit be 8 mol % or less. In addition, it is preferable that the lower limit thereof exceed 4 mol %. According to this configuration, the pretilt angle may be set to be within a very appropriate range.

The photo-alignment film includes the film formed using the alignment film material and a film formed from a material other than the alignment film material, a surface portion of the photo-alignment film on a liquid crystal layer side is essentially composed of the film formed using the alignment film material, and in a case where a ratio of a solid-content of the material other than the alignment film material to 100 weight % of a solid-content of the alignment film material and the material other than the alignment film material is set to a modification rate, it is preferable that the modification rate exceed 70 weight % and be equal to or less than 90 weight %. In addition, in this specification, a base polymer that is not localized to a surface on a liquid crystal layer side is called a modification treatment material, and in other words, the modification rate represents a ratio of a solid-content of the modification treatment material to a total weight of a solid-content of the alignment film material and the modification treatment material.

According to this, a structural composition of a polymer that is preferable as a photo-alignment film and is excellent in electro-optical properties may be clarified. In this specification, the “film formed from a material other than the alignment film material” may be a film, which may be determined to be different from a film formed in a surface portion of the photo-alignment film on a liquid crystal layer side using the alignment film material (hereinafter, also referred to as a film formed in a surface portion of the photo-alignment film on a liquid crystal layer side), in a technical field of the invention. Among these, with regard to the “film formed from a material other than the alignment film material”, it is preferable that the introduction ratio of the second constituent unit be higher compared to the film that is formed in the surface portion of the photo-alignment film on a liquid crystal layer side. It is particularly preferable that the “film formed from a material other than the alignment film material” be a film in which the introduction ratio is 100 mol %, that is, a film formed using a polymer that substantially does not contain the first constituent unit and a material that is not a new chemical material. According to this, it is possible to reduce the used amount of the photo-alignment diamine or the original material having the photo-alignment properties as described above. In addition, in other words, a configuration in which a photo-alignment film layer of the photo-alignment film is localized on the surface of at least one substrate on a liquid crystal layer side is suitable. With regard to the above-described localization, it is not necessary for it to be completely localized, and it may be localized to a degree capable of exhibiting the effect of the invention. For example, a configuration in which the introduction ratio of the second constituent unit exceeds 4 mol % and is equal to or less than 8 mol %, and the modification rate exceeds 70 weight % and is equal to or less than 90 weight % is suitable. In addition, a configuration, in which the polymer constituting the layer of the photo-alignment film on a substrate side, and the polymer constituting the layer of the photo-alignment film on a liquid crystal side are mixed, is preferable.

It is preferable that the photo-alignment film perform the alignment control of the liquid crystal molecules in such a manner that an average pretilt angle of the liquid crystal layer becomes 88.6°±0.3°. When the average pretilt angle is within this range, this may be determined to be within a permissible range in the technical field of the invention, and the deviation amount of the gray scale may be sufficiently reduced. In addition, when the deviation amount of the gray scale is set to be within ±2 gray scales, a more preferable range is 88.6°±0.15°. In addition, when the deviation amount of the gray scale is set to be within ±1 gray scale, a still more preferable range is 88.6°±0.1°.

The photo-alignment film includes the film formed using the alignment film material and a film formed using a material other than the alignment film material, and a surface portion of the photo-alignment film on a liquid crystal layer side is essentially composed of the film formed using the alignment film material. In a case where a ratio of a solid-content of the material other than the alignment film material to 100 weight % of a solid-content of the alignment film material and the material other than the alignment film material is set to a modification rate, it is preferable that when the introduction ratio of the second constituent unit is equal to or more than 0 mol % and less than 4 mol %, the modification rate be 0 to 63 weight %, when the introduction ratio is 4 mol %, the modification rate be 30 to 90 weight %, when the introduction ratio exceeds 4 mol % and is equal to or less than 6 mol %, the modification rate be 63 to 90 weight %, and when the introduction ratio of the second constituent unit exceeds 6 mol % and is equal to or less than 8 mol %, the modification rate be 83 to 90 weight %.

According to this configuration, a preferable range of the pretilt angle may be satisfied from the viewpoint of optical properties, and thus this is preferable.

In the invention, since the introduction ratio of the second constituent unit exceeds 4 mol % and is equal to or less than 10 mol %, a type in which when the introduction ratio of the second constituent unit exceeds 4 mol % and is equal to or less than 6 mol %, the modification rate is 63 to 90 weight %, and a type in which when the introduction ratio of the second constituent unit exceeds 6 mol % and is equal to or less than 8 mol %, the modification rate is 83 to 90 weight % are preferable.

It is preferable that the setting range of the modification rate exceed 70 weight % as described above so as to exhibit an operational effect of solving occurrence of stain irregularity or image-sticking caused by the residual DC. Therefore, a configuration, in which when the introduction ratio of the second constituent unit exceeds 4 mol % and is equal to or less than 6 mol %, the modification rate exceeds 70 weight % and is equal to or less than 90 weight %, is more preferable.

As described above, introduction of the non-photo-alignment diamine unit in an amount exceeding 4 mol % is preferable from the viewpoints of a display quality and reliability of the liquid crystal panel. In the invention, it is preferable to satisfy the above-described numerical range of the introduction ratio of the second constituent unit and/or the modification rate, or a relationship between the introduction ratio of the second constituent unit and the modification rate, but the introduction ratio and the modification rate may have a configuration that satisfies the above-described pretilt range that is not problematic in a display quality and reliability aspect.

It is preferable that the photo-alignment film perform the alignment control of the liquid crystal molecules in such a manner that a difference in the pretilt angle between a case where an application time of an AC voltage to the liquid crystal display panel is set to 0 hour and a case where the application time is set to an average value of 36 to 40 hours becomes −0.05° or more. In other words, it is preferable that the photo-alignment film in the liquid crystal display panel perform the alignment control of the liquid crystal molecules in such a manner that a difference (in this specification, may be referred to as Δtilt) in the pretilt angle between a case where an application time of an AC voltage to the liquid crystal display panel is set to 0 hour and a case where the application time is set to a simple arithmetic average of 36 to 40 hours becomes −0.05° or more. In addition, the simple arithmetic average represents that an average value is obtained by a recent five-point average-value method in consideration of a measurement error, that is, a value of Δtilt is measured from a point of time after 36 hours to a point of time after 40 hours by an interval of one hour, and the values at the five points are averaged.

More preferably, for example, a difference in pretilt angle between a case where the application time is set to 0 hour and a case where the application time is set to 36 hours is −0.05° or more.

The photo-alignment film includes the film formed using the alignment film material and the film formed using a material other than the alignment film material, and a surface portion of the photo-alignment film on a liquid crystal layer side is essentially composed of the film formed using the alignment film material. In a case where a ratio of a solid-content of the material other than the alignment film material to 100 weight % of a solid-content of the alignment film material and the material other than the alignment film material is set to a modification rate, it is preferable that when the introduction ratio of the second constituent unit exceeds 4 mol % and is less than 6 mol %, the modification rate be 0 to 85 weight %, and when the introduction ratio is 6 to 10 mol %, the modification rate be 0 to 90 weight %. According to this configuration, a range of Δtilt, which is preferable from the viewpoint of image-sticking properties, may be satisfied.

It is preferable that the first constituent unit of the polymer in the alignment film material have a side chain having a photo-functional group. In addition, it is preferable that the second constituent unit of the polymer in the alignment film material have a side chain having an alignment functional group. Preferred configuration examples as a combination of the constituent units include a configuration in which the first constituent unit has two kinds of side chains including a vertical alignment (VA) side chain (first constituent unit (1)) having a photo-functional group and a different kind of side chain (first constituent unit (2)), a configuration in which the first constituent unit has a vertical alignment side chain having the photo-functional group, and the second constituent unit has a vertical alignment side chain not having the photo-functional group, a configuration in which the first constituent unit has a vertical alignment side chain having the photo-functional group, and the second constituent unit has a vertical alignment side chain (second constituent unit (1)) not having the photo-functional group, and a different kind of side chain (second constituent unit (2)), and the like. Here, the different kind of side chain also includes a side chain in which a linking group to a main chain is different.

It is preferable that the essential constituent unit of the polymer in the alignment film material have the same alignment control direction. The term “same direction” may be any direction as long as an alignment control direction is considered as the same direction in the technical field of the invention, and may be substantially the same direction.

It is preferable that the photo-alignment film perform a uniform alignment control of the liquid crystal molecules within an alignment film surface. The term “uniform” is acceptable as long as the alignment of the liquid crystal molecules is considered to be uniformly controlled in the technical field of the invention, and may be substantially uniform.

It is preferable that the photo-alignment film be a vertical alignment film that performs a vertical alignment control of the liquid crystal molecules. For example, it is preferable that the vertical alignment film perform the vertical alignment control of the liquid crystal molecules during voltage not-application.

It is preferable that the second constituent unit of the polymer in the alignment film material have a side chain having a vertical alignment functional group. In other words, it is preferable that the alignment functional group be a vertical alignment functional group. The “vertical alignment” in the “vertical alignment control” and “vertical alignment property” may be any alignment as long as this alignment is considered as vertical alignment in the technical field of the invention, and may be acceptable as long as substantially vertical alignment control is performed.

It is preferable that the first constituent unit of the polymer in the alignment film material have a side chain having at least one photo-functional group selected from a group consisting of a coumarin group, a cinnamate group, a chalcone group, an azobenzene group, and a stilbene group. In other words, it is preferable that the above-described photo-functional group be at least one selected from a group consisting of a coumarin group, a cinnamate group, a chalcone group, an azobenzene group, and a stilbene group.

It is preferable that the second constituent unit of the polymer in the alignment film material have a side chain having a steroid skeleton. In other words, it is preferable that the alignment functional group have a steroid skeleton.

It is preferable that the second constituent unit of the polymer in the alignment film material have a side chain having a structure in which, for example, 3 to 4 rings selected from any one of 1-4-cyclohexylene and 1,4-phenylene are linearly coupled directly or through 1,2-ethylene. In other words, the second constituent unit may have three or four pieces of 1-4-cyclohexylene, may have three or four pieces of 1,4-phenylene, or may have both 1-4-cyclohexylene and the 1,4-phenylene and the number of total pieces thereof may be 3 or 4 pieces.

It is preferable that the polymer in the alignment film material have a main chain structure of at least one selected from a group consisting of polyamic acid, polyimide, polyamide, and polysiloxane. In addition, the polymer may have the main chain structure at a portion, which may be mentioned as a side chain portion diverged from the main chain in the technical field of the invention, as long as the effect of the invention may be exhibited.

It is preferable that the essential constituent unit of the polymer in the alignment film material be formed by diamine. With regard to the formation by diamine, the polymer may be constituted by a monomer unit derived from a monomer component essentially composed of diamine, and there is not limitation to a configuration in which the polymer is composed of only a monomer unit derived from diamine. For example, it is particularly preferable that the polymer in the alignment film material be a copolymer of a monomer component that contains at least one of diamine, acid dianhydride, and dicarboxylic acid.

With regard to the polymer in the alignment film material, it is preferable that the monomer component of the second constituent unit exceed 4 mol % and be equal to or less than 10 mol % on the basis of 100 mol % of a total amount of the monomer component of the first constituent unit and the monomer component of the second constituent unit, more preferably 6 to 10 mol %.

It is preferable that the liquid crystal display panel include pixels that are arranged in a matrix shape, each pixel having a pixel electrode disposed on one substrate on a liquid crystal layer side in a matrix shape, and a common electrode disposed on the other substrate on a liquid crystal layer side, and the pixel have two or more domains that are adjacently disposed.

It is preferable that the domains have liquid crystal pretilt in directions different from each other. For example, in a case of having two domains, it is preferable that the two domains have the liquid crystal pretilt in directions opposite to each other. In a case of having four domains, it is preferable that four division domains in which four alignment directions of the liquid crystal molecules are different from each other be formed by dividing each substrate with a pitch of two-division or the like and disposing both substrates in such a manner that division directions intersect each other.

According to another aspect of the invention, there is provided a liquid crystal display panel (also, referred to as a second invention) has a configuration in which a liquid crystal layer containing liquid crystal molecules is interposed between a pair of substrates, and includes a photo-alignment film on a surface of at least one substrate on a liquid crystal layer side. The photo-alignment film contains a polymer including a third constituent unit having a structure derived from a photo-functional group, and a fourth constituent unit that does not have the photo-functional group and the structure derived from the photo-functional group and has an alignment functional group as essential constituent units. An introduction ratio of the fourth constituent unit exceeds 4 mol % and is equal to or less than 10 mol % on the basis of 100 mol % of a total of the third constituent unit and the fourth constituent unit.

This configuration may exhibit the operational effect of the invention in the same manner.

For example, the third constituent unit having a structure derived from the photo-functional group has a structure in which a photo-functional group of a cis-isomer (or a trans-isomer) is changed to a photo-functional group of a trans-isomer (or a cis-isomer) through an excitation state due to photo-irradiation. A photo-reorientation structure of the photo-functional group is a structure resulting from photo-realignment of a photo-functional group. In addition, the photo-rearrangement means that only a direction of a photo-functional group is changed due to photo-irradiation without isomerization of the photo-functional group. Accordingly, the third constituent unit has, for example, a structure obtained when a direction of a photo-functional group of a cis-isomer (or trans-isomer) is changed through an excitation state by photo-irradiation while maintaining isomerization thereof as is. That is, the structure derived from the photo-functional group means a functional group in which even though having properties of a dimerization reaction, a reversible change of a photo-isomerization reaction mainly occurs with low-energy light. In other words, the structure derived from the photo-functional group may be a structure in which the reversible reaction of the photo-isomerization occurs.

The preferred aspect of the second invention is similar to the preferred aspect of the first invention described above. In addition, the preferred aspect of the liquid crystal display panel in the second invention may be appropriately applied to a configuration obtained by appropriately substituting the preferred aspect of the first constituent unit and the second constituent unit in the first invention with the preferred aspect of the third constituent unit and the fourth constituent unit in the second invention as long as the operational effect of the invention is exhibited.

In the photo-alignment film, it is preferable that the polymer constituting the film on a substrate side be a polymer of a horizontal alignment film, and the polymer constituting the film on a liquid crystal layer side be a polymer of a vertical alignment film. In other words, a configuration, in which the film formed by the modification treatment material is the horizontal alignment film, and the film formed using the alignment film material is the vertical alignment film, is preferable.

According to this, since a used amount of the material that forms the polymer of the vertical alignment film is reduced, the cost of the photo-alignment film material may be reduced, and a liquid crystal display panel, which is a vertical alignment type during application of a voltage, may be appropriately obtained.

According to still another aspect of the invention, there is provided a liquid crystal display device having the liquid crystal display panel of the invention. A preferred aspect of the liquid crystal display panel that is provided to the liquid crystal display device of the invention is similar to the above-described preferred aspect of the liquid crystal display panel of the invention.

According to still another aspect of the invention, there is provided a polymer for an alignment film material. The polymer includes a polymer including the first constituent unit and the second constituent unit as essential constituent units or a polymer including the third constituent unit and the fourth constituent unit as essential constituent units, each polymer being contained in the alignment film material that forms the photo-alignment film provided to the liquid crystal display panel of the invention. A preferred aspect of the polymer for the alignment film material of the invention is similar to the preferred aspect of the polymer for the alignment film material that is used in the liquid crystal display panel of the invention.

The configuration of the liquid crystal display panel and the liquid crystal display device of the invention may include other constituent elements constituting the liquid crystal panel and the liquid crystal display device, in addition to the essential constituent element in which the above-described specific photo-alignment film is provided, or the above-described preferred constituent element. This is true of the configuration of the polymer for the alignment film material of the invention. Other constituent elements are not particularly limited.

The above-described respective aspects may be appropriately combined within a range not departing from the gists of the invention.

### Advantages

According to the liquid crystal display panel, the liquid crystal display device, and the polymer for the alignment film material of the invention, a structural composition of a polymer, which is preferable as a photo-alignment film, may be suggested while realizing excellent display quality, reliability, and electro-optical properties.

### BRIEF DESCRIPTION OF DRAWINGS

FIG. 1 is a schematic view illustrating a basic structure of a molecule of a photo-alignment film polymer that may be used in Embodiment 1.

FIG. 2 is a configuration cross-sectional view after baking of a substrate related to Embodiment 1, and a view illustrating a configuration of a photopolymer.

FIG. 3 is a schematic perspective view illustrating a relationship between a UV-light alignment treatment direction and a pretilt direction of a liquid crystal molecule in Embodiment 1.

FIG. 4 is a view illustrating a photo-alignment mechanism of Embodiment 1.

FIG. 5 is a view illustrating the photo-alignment mechanism of Embodiment 1.

FIG. 6 is a schematic plan view illustrating a direction of a liquid crystal director in one pixel (one pixel or one sub-pixel) and a photo-alignment treatment direction with respect to a pair of substrates (upper and lower substrates) in a case where a liquid crystal display device of Embodiment 1 has a monodomain.

FIG. 7 is a schematic plan view illustrating a direction of the liquid crystal director in one pixel (one pixel or one sub-pixel) and a photo-alignment treatment direction with respect to a pair of substrates (upper and lower substrates) in a case where the liquid crystal display device of Embodiment 1 has a monodomain.

FIG. 8 is a schematic cross-sectional view illustrating a first dispositional relationship between a substrate and a photomask in a divisional photo-alignment treatment process by mask alignment according to a proxy UV exposure method.

FIG. 9 is a schematic cross-sectional view illustrating a second dispositional relationship between the substrate and the photomask in the divisional photo-alignment treatment process by the mask alignment according to the proxy UV exposure method.

FIG. 10 is a schematic plan view illustrating a liquid crystal display device, a liquid crystal division pattern and a photo-alignment treatment direction of one pixel, and an average liquid crystal director direction during application of a voltage of 7.5 V.

FIG. 11 is a schematic plan view illustrating a liquid crystal division pattern of one pixel, a UV photo-irradiation direction, and a liquid crystal alignment direction in the liquid crystal display device of Embodiment 1.

FIG. 12 is a cross-sectional view taken along a line A-B in FIG. 11 during application of a voltage and is an alignment cross-sectional view of liquid crystal molecules.

FIG. 13 is a graph illustrating standardized transmittance (a.u.) against a voltage in a pretilt permissible range analysis.

FIG. 14 is a graph illustrating standardized transmittance (a.u.) against a gray scale level.

FIG. 15 is a graph illustrating the standardized transmittance (a.u.) against the gray scale level.

FIG. 16 is a graph illustrating the gray scale level (a.u.) against the gray scale level (a.u.) of reference evaluation cell.

FIG. 17 is a graph illustrating a difference in gray scale level (a.u.) against the gray scale level (a.u.) of the reference evaluation cell.

FIG. 18 is a graph illustrating the standardized transmittance (a.u.) against the gray scale level (a.u.).

FIG. 19 is a graph illustrating an actual gray scale level (a.u.) at γ=2.2 against the gray scale level (a.u.).

FIG. 20 is a graph illustrating a difference in the gray scale level (a.u.) against the gray scale level (a.u.).

FIG. 21 is a graph illustrating a deviation amount of the gray scale against a pretilt angle/degree.

FIG. 22 is a graph illustrating the pretilt angle/degree against a modification rate in Embodiment 1.

FIG. 23 is a graph illustrating Δtilt against the modification rate in Embodiment 1.

FIG. 24 is a graph illustrating a voltage holding ratio (VHR)/% against the modification rate in Embodiment 1.

FIG. 25 is a bar graph illustrating the voltage holding ratio (VHR)/% against the modification rate and an introduction ratio of a second constituent unit in Embodiment 1.

FIG. 26 is a graph illustrating a residual DC/V against the modification rate in Embodiment 1.

FIG. 27 is a bar graph illustrating the residual DC/V against the modification rate and the introduction ratio of the second constituent unit in Embodiment 1.

FIG. 28 is a graph illustrating a liquid crystal dependency of the pretilt angle/degree occurred by the alignment film.

FIG. 29 is a bar graph illustrating the liquid crystal dependency of the pretilt angle/degree occurred by the alignment film.

### BEST MODES FOR CARRYING OUT THE INVENTION

In this specification, an introduction ratio of a second constituent unit is a value when the total of a first constituent unit and the second constituent unit is set to 100 mol %. Similarly, an introduction ratio of a fourth constituent unit is a value when the total of a third constituent unit and the fourth constituent unit is set to 100 mol %.

### Embodiment 1

### Photo-Alignment Film Material

The photo-alignment film material in this embodiment exhibits vertical alignment properties that may be used in a VA (Vertical Alignment) mode. Examples of a material, which causes a photo-chemical reaction (it is considered that the material of an example of the invention has a dimerization properties but uses a reaction in which photo-isomerization mainly occur) to occur to apply a pretilt angle to liquid crystal, include polyimides or polyamides that have cinnamate, cinnamoyl, azobenzene, or coumarin, polysiloxane derivatives, and the like. In addition, examples of a material that causes a photo-decomposition reaction to occur and applies pretilt to liquid crystal include polyvinyl alcohol, polyamide, polyimide, polysiloxane derivatives, and the like. In addition, the invention is not limited to this embodiment, and may be applied to a horizontal alignment film constituted by a copolymer of a derivative of imide, amide, or the like that has a photo-functional group, and a derivative of imide, amide, or the like that does not have the photo-functional group even in a use of horizontal alignment TN or ECB, or IPS (In-Plane-Switching).

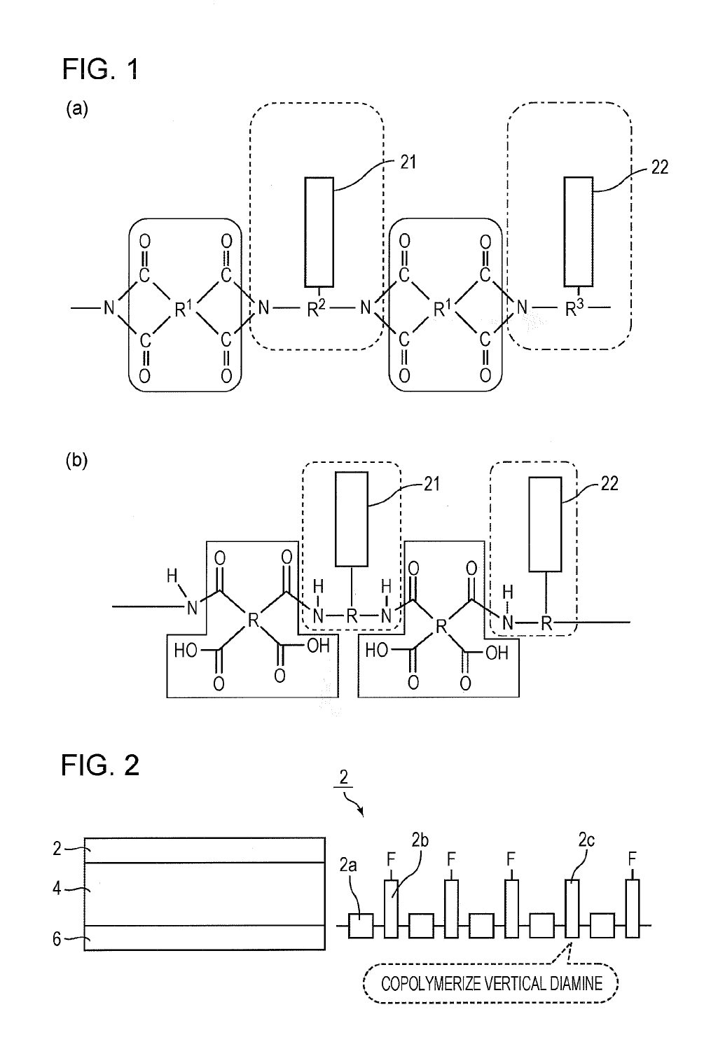

FIGS. 1(a) and 1(b) show schematic views illustrating a basic structure of a molecule of a photo-alignment film polymer that may be used in Embodiment 1.

FIG. 1(a) shows a polyimide structure, and FIG. 1(b) shows a polyamic acid structure. In addition, all of a photopolymer and a base polymer that are actually used in this embodiment have a polyamic acid structure, and a part of each of the polymers is thermally imidized after baking.

A vertical photo-alignment film, in which the copolymer of the derivative of imide, amide, or the like that has a photo-functional group and the derivative of imide, amide, or the like that does not have the photo-functional group is formed, is formed. In addition, in FIGS. 1(a) and 1(b), a portion surrounded by a solid line represents a unit (acid dianhydride unit) derived from an acid dianhydride, and a portion surrounded by a broken line represents a unit (photo-alignment diamine unit) derived from diamine that has a side chain having a photo-functional group. A portion surrounded by one-dot chain line represents a unit (vertical alignment diamine) derived from diamine that has a side chain having a vertical alignment functional group. In addition, a unit introduction composition of a photo-alignment side chain having a photo-alignment group and a side chain not having the photo-functional group in the invention is applicable to a material in which a main chain has a polysiloxane structure.

(Example of Acid Dianhydride)

Very suitable examples of the acid dianhydride that is used in Embodiment 1 include acid dianhydrides expressed by the following formulae (1-1) to (1-8). An acid dianhydride (4,10-dioxatricyclo(6,3,1,0)dodecane-3,5,9,11-tetraone) expressed by the following formula (I-6) is particularly preferable. In addition, an alphabet written together with a formula number is an abbreviation of each compound.

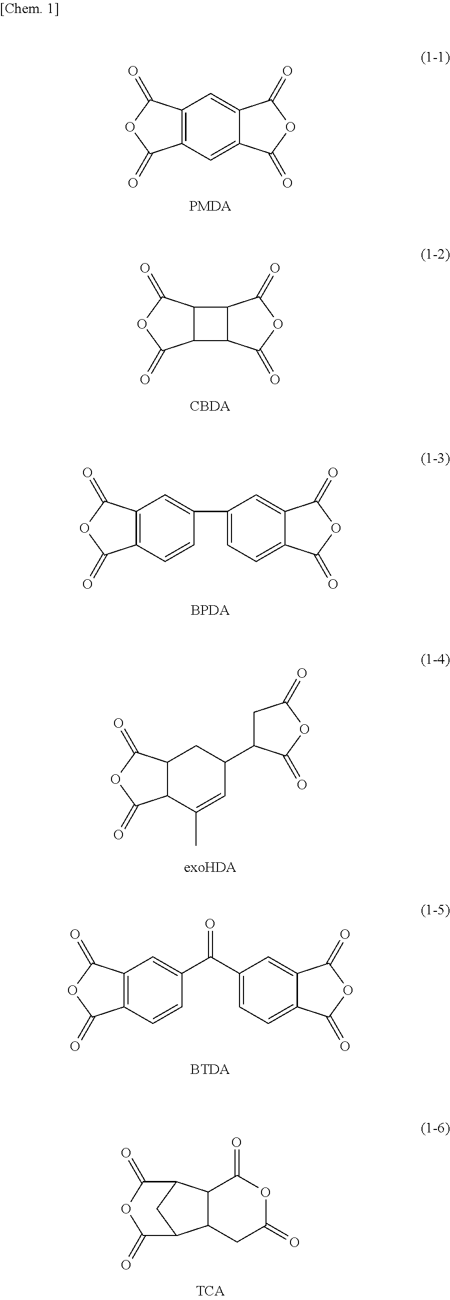

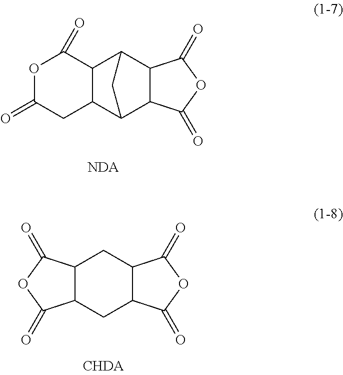 [SMILES: O=C1CC2C3CC(C2C(=O)O1)C1C(=O)OC(=O)C31 ; O=C1OC(=O)C2CC3C(=O)OC(=O)C3CC12]

As a suitable example of a vertical diamine material that is used in Embodiment 1, materials having structures shown in the following formulae (2-1) to (2-13), and the like. In addition, as a type in which two or more kinds of these materials are used, particularly, a plurality of other constituent units may be introduced in an amount of 1 mol % or more on the basis of 100 mol % of diamine.

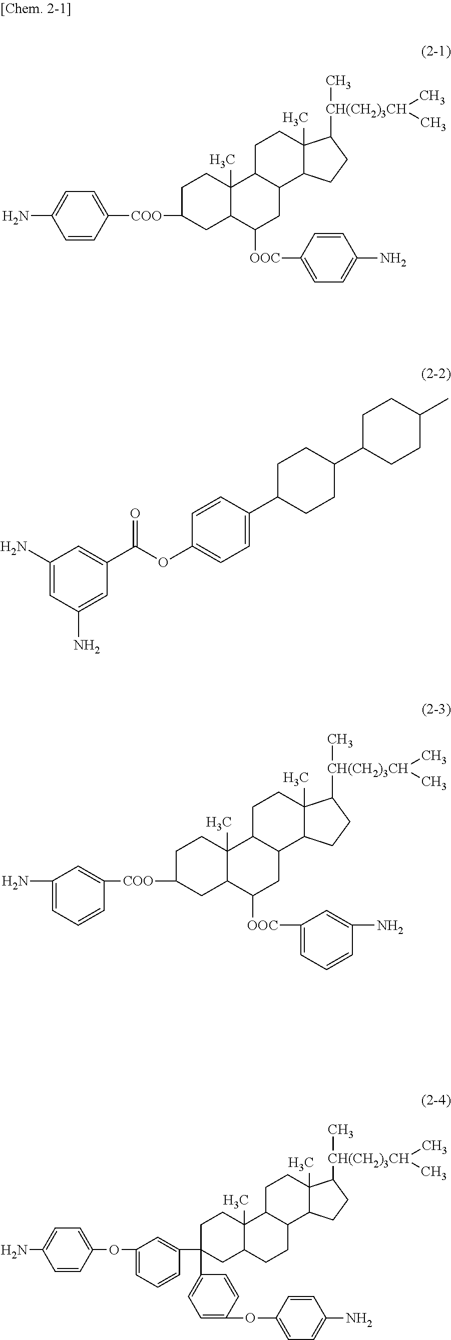

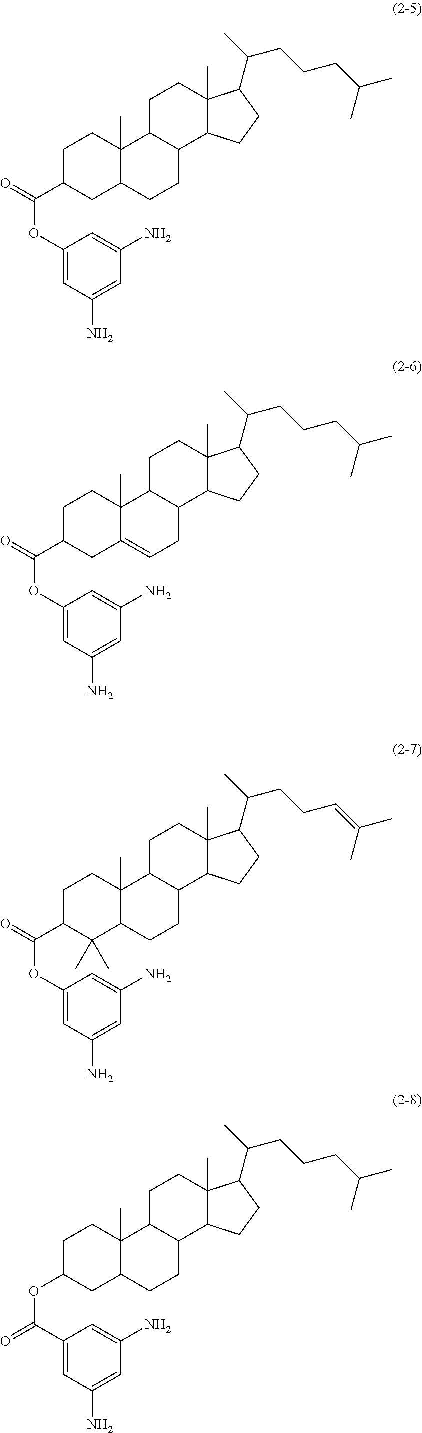 [SMILES: CC(C)CCCC(C)C1CCC2C3CCC4CC(C(=O)Oc5cc(N)cc(N)c5)CCC4(C)C3CCC12C ; CC(C)CCCC(C)C1CCC2C3CC=C4CC(C(=O)Oc5cc(N)cc(N)c5)CCC4(C)C3CCC12C ; CC(C)=CCCC(C)C1CCC2C3CCC4C(C)(C)C(C(=O)Oc5cc(N)cc(N)c5)CCC4(C)C3CCC12C ; CC(C)CCCC(C)C1CCC2C3CCC4CC(OC(=O)c5cc(N)cc(N)c5)CCC4(C)C3CCC12C]

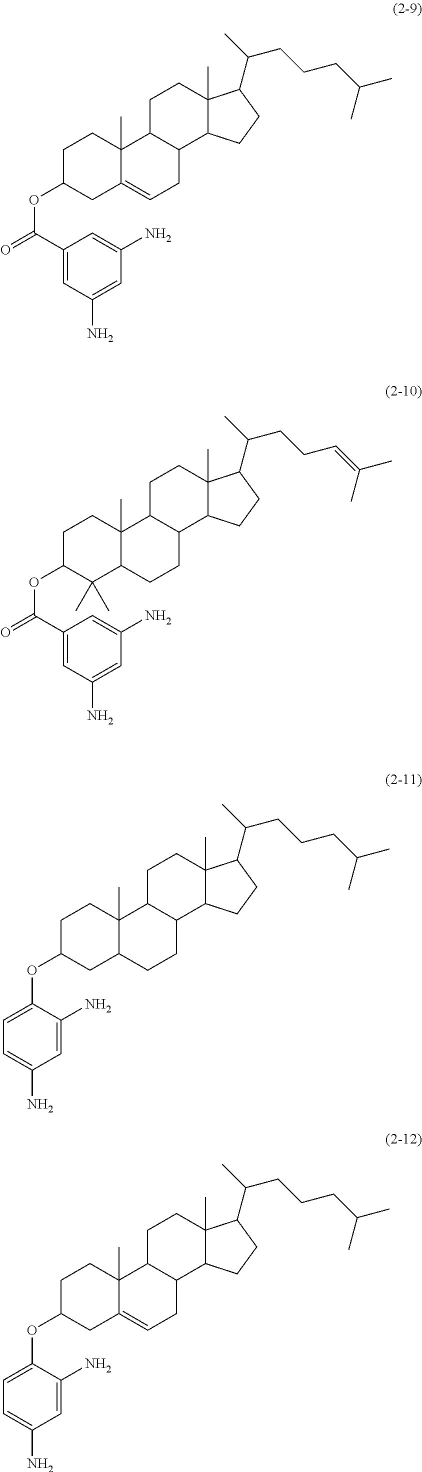 [SMILES: CC(C)CCCC(C)C1CCC2C3CC=C4CC(OC(=O)c5cc(N)cc(N)c5)CCC4(C)C3CCC12C ; CC(C)=CCCC(C)C1CCC2C3CCC4C(C)(C)C(OC(=O)c5cc(N)cc(N)c5)CCC4(C)C3CCC12C ; CC(C)CCCC(C)C1CCC2C3CCC4CC(Oc5ccc(N)cc5N)CCC4(C)C3CCC12C ; CC(C)CCCC(C)C1CCC2C3CC=C4CC(Oc5ccc(N)cc5N)CCC4(C)C3CCC12C]

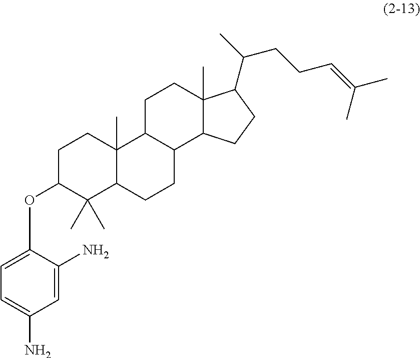 [SMILES: CC(C)=CCCC(C)C1CCC2C3CCC4C(C)(C)C(Oc5ccc(N)cc5N)CCC4(C)C3CCC12C]

In addition, for example, diamine disclosed in Japanese Unexamined Patent Application Laid-Open No. 2004-67589 and Japanese Unexamined Patent Application Laid-Open No. 2008-299317 may be appropriately used.

The photo-alignment diamine that is used in Embodiment 1 may be a photo-alignment diamine having a photo-functional group (photo-reactive group), but a material having a cinnamoyl group, a cinnamate group, a chalcone group, an azo group, a stilbene group, or a coumarin group of a structure shown in the following formulae (3-1) to (3-5), and the like are preferable. In addition, in this specification, the photo-functional group may be a functional group that may cause a photo-reaction to occur in the technical field of the invention, and for example, a functional group that may cause photo-cross-linking (dimerization), photo-isomerization (cis-trans reaction), or both photo-cross-linking and photo-isomerization to occur is suitable.

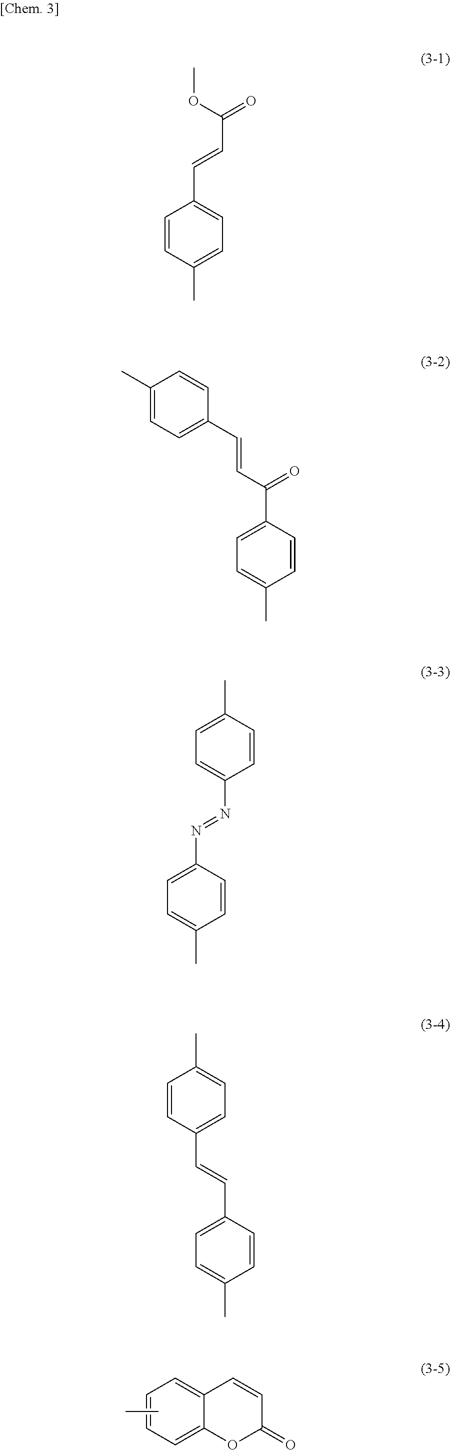

As the photo-alignment diamine that is used in Embodiment 1, a diamine compound described in Japanese Translation of a PCT Application Laid-Open No. 2009-520702 (Patent Document 7) may be appropriately used. In addition, a compound expressed by formula (4) is preferable. Among these, a type having a cinnamate group, and/or a type having 1 to 5 fluorine atoms are preferable. In the following formula (4), R¹ and R² are the same as each other or different from each other and represents an alkyl group having 1 to 12 carbon atoms. A represents an aromatic group having 5 to 14 carbon atoms, and a part of hydrogen atoms contained in the aromatic group or the entirety thereof may be substituted with a fluorine atom or a chlorine atom. B represents an alkyl group having 1 to 16 carbon atoms. B represents a diamine group having 1 to 40 carbon atoms. E represents an aromatic group, an oxygen atom, a sulfur atom, —NR³—, or —CR⁴R⁵—, R³ represents a hydrogen atom or an alkyl group having 1 to 6 carbon atoms. R⁴ and R⁵ are the same as each other or different from each other, and represents a hydrogen atom or an alkyl group having 1 to 24 carbon atoms. X and Y are the same as each other or different from each other, and represents hydrogen, fluorine, chorine, a cyano group, or an alkyl group that has 1 to 15 carbon atoms (preferably, an alkyl group having 1 to 12 carbon atoms) and is not substituted or substituted with fluorine. M and n are the same as each other or different from each other, and are integers of 1 to 4. In addition, in the formula (4), the fluorine atom (F) may be substituted with a dialkylamino group having 2 to 32 carbon atoms, an alkyloxy group having 1 to 6 carbon atoms, a nitro group, and/or chlorine. Furthermore, it is particularly preferable that the n be 1. In other words, it is suitable for the photo-alignment diamine in the invention to be composed of one main chain without being diverged. The composition of one main chain is acceptable as long as the photo-alignment diamine is substantially composed of one main chain in the technical field of the invention.

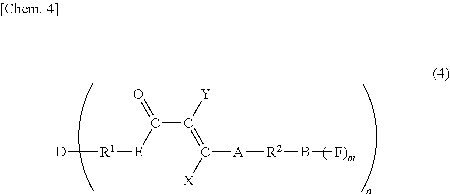

Very appropriate specific examples of the photo-alignment diamine include a compound (4-(4,4,4-trifluorobutoxy)benzoic acid 4-{2-[2-(2,4-diaminophenyl)ethoxycarbonyl]-2-(E)-vinyl}phenyl ester) that is shown in the following formula (5).

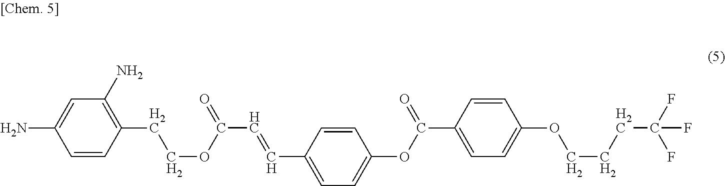 [SMILES: Nc1ccc(CCOC(=O)/C=C/c2ccc(OC(=O)c3ccc(OCCCC(F)(F)F)cc3)cc2)c(N)c1]

In addition, the above-described polymerization of the photo-alignment film material may be synthesized by a technology in the related art (Japanese Unexamined Patent Application Laid-Open No. 2007-224273, Japanese Unexamined Patent Application Laid-Open No. 2007-256484, and the like).

An introduction ratio (vertical diamine material) of a derivative of imide, amide, or the like, which does not have a photo-functional group, is set to 0 mol %, 4 mol %, 6 mol %, or 10 mol % to unify photo-alignment diamine, a photo-alignment film material is polymerized, and varnish is adjusted with a solvent for inkjet printing. With regard to pretilt, Δtilt, VHR, and residual DC properties, dependency on the introduction ratio of the derivative of imide, amide, or the like, which does not have the photo-functional group, is investigated.

As a solvent of the varnish for inkjet printing to a substrate, a mixed solvent of γ-butyl lactone (BL), N-methyl pyrrolidone (NMP), diethylene glycol diethyl ether (DEDG), and diisobutyl ketone (DIBK) is preferable. In addition, in rotary press printing, BL, or a mixed solvent of NMP and BC are preferable.

FIG. 2 shows a conceptual cross-sectional view illustrating a configuration after baking of a substrate related to Embodiment 1, and a conceptual view illustrating a configuration of a photopolymer. As shown in the configuration cross-sectional view after baking of a substrate, in the photo-alignment film of this embodiment, two layer of a modification treatment material (base polymer) 4 and a photopolymer 2 are laminated in this order from a substrate 6. In this type, it can be said that in an alignment film formed using the base polymer as a base material, a surface thereof on a liquid crystal layer side and the vicinity of the surface are modified with the photopolymer. The expression of the modification treatment material represents that the material that becomes a base material to which a modification treatment is performed by the photopolymer. When the base polymer is 0 weight % on the basis of 100 weight % of the alignment film, the alignment film is not modified, and as the weight % of the photopolymer 2 decreases, a modification rate increases. A function of aligning liquid crystal molecules in the alignment film is exhibited by the photopolymer 2, and thus a function of realizing a decrease in a volume of the alignment film exposed to a liquid crystal side, reduction in use of a new chemical material, maintaining of a film thickness of the alignment film, and reduction in a residual DC is exhibited at the alignment film as a whole. In addition, in the conceptual cross-sectional view of FIG. 2, a boundary between the base polymer and the photopolymer 2 is clearly shown, but in an actual type, the boundary may not be clear, and a ratio of the photopolymer may decrease in a gradient manner from a liquid crystal side of the alignment film. That is, a type, in which the alignment film is formed in a state in which the photopolymer 2 and the base polymer are classified into two layers, is one preferable type, but the photopolymer 2 may be unevenly distributed on the surface of the alignment film on a liquid crystal side so as to accomplish a function of aligning liquid crystal molecules. In addition, in the same modification treatment as the polymer for a vertical alignment film, in a case of a polymer having a side chain to which fluorine is not introduced and a polymer having a side chain to which fluorine is introduced (side-chain terminal substitution), it was confirmed that a layer is separated into a non-fluorine polymer on a substrate side and a fluorine polymer on a surface side. Accordingly, even in the vertical alignment film of the polymer having the fluorine not-introduced side chain, which is capable of causing the layer separation from the fluorine-containing photo-optical alignment film to occur as described above, use as a base polymer of a modification treatment material is possible.

In the conceptual view of FIG. 2 illustrating a configuration of the photopolymer 2, a preferred type of the photopolymer 2, which is a film formed at a surface portion on a liquid crystal layer side, includes a monomer unit 2a formed from an acid dianhydride, and a monomer unit 2b formed from photo-alignment diamine, and a monomer unit 2c formed from non-fluorine diamine (for example, the above-described vertical diamine) as a constituent unit. The non-fluorine diamine may be vertical diamine having a so-called liquid crystal molecule vertical alignment function, and may be diamine having a fluorine atom. According to this, a used amount of the photo-alignment diamine may be suppressed, and the cost thereof may be reduced. In this type, a distribution aspect of the monomer unit may be any one of a random aspect, a block aspect, and an alternating aspect, a type in which the monomer unit 2a formed from the acid dianhydride, and the monomer unit 2b formed from the photo-alignment diamine, and the monomer unit 2c formed from the non-fluorine diamine are alternately present is preferable. Here, it is preferable that the monomer unit 2c formed from the non-fluorine diamine be distributed in the polymer in such a manner that the monomer unit 2c is not too deviated. In the conceptual view of FIG. 2, illustration is made as if F (fluorine atom) is coupled to a side-chain terminal of the monomer unit 2b formed from the photo-alignment diamine. Like this configuration, a type in which F is coupled to the side-chain terminal of the monomer unit is preferable, but there is no particular limitation as long as the function of aligning liquid crystal molecules in a photo-irradiation direction is accomplished in the alignment film formed by photo-irradiation.

The non-fluorine diamine that is a constituent material of the copolymer of the photopolymer 2 functions to cause pretilt to be vertically erected, improves uniform alignment of the liquid crystal molecules during application of a voltage, and suppresses ACM caused by a variation in pretilt with respect to the voltage.

For example, when an introduction ratio of the vertical diamine that is a second constituent unit is set to exceed 4 mol % and be equal to or less than 10 mol % on the basis of 100 mol % of a total of the photo-alignment diamine that is a first constituent unit and the vertical diamine that is the second constituent unit, as described to be later, in practical use, a uniform display quality, sufficient reliability, and excellent electro-optical properties are realized while setting the modification rate to a relatively higher value, and thus a structural composition of the polymer that is preferable as the photo-alignment film may be suggested. More preferably, the introduction ratio is 8 mol % or less.

(Method of Preparing Alignment Film)

Hereinafter, a method of preparing the alignment film of this embodiment will be described.

First, monomer components of the first constituent unit and the second constituent unit, and the acid dianhydride are copolymerized by a method that is known in the related art.

Next, the varnish for inkjet application (printing) of the copolymerized polymer to a substrate is adjusted. A mixed solvent that contains solvents such as γ-butyl lactone (BL), N-methylpyrrolidone (NMP), diethylene glycol diethyl ether (DEDG), and diisobutyl ketone (DIBK) (including an isomer mixture) is preferable as a solvent of the varnish. For example, a type of using 30 weight % of 7-butyl lactone, 20 weight % of N-methylpyrrolidone, 40 weight % of diethylene glycol diethyl ether dibutyl glycol, and 10 weight % of diisobutyl ketone (DIBK) (including an isomer mixture) is preferable.

Next, the varnish is applied to the substrate. As a method of applying the varnish, spin coating, flexgraphic printing, inkjet, and the like are suitable.

After being printed on the substrate, the varnish is pre-baked with a hot plate for pre-baking, and then is post-baked with a hot plate for post-baking. In addition, in the pre-baking and post-baking, a heating temperature and a heating time may be appropriately set. In addition, the film thickness of the alignment film of this embodiment may be appropriately set.

The alignment film of this embodiment may be formed by methods called a modification treatment, two-layer treatment, and hybridization. Until now, a residual DC is considered as a main cause of the image-sticking of the liquid crystal display device. The larger the film thickness (volume) of the alignment film is, the larger the residual DC is. Accordingly, the smaller the film thickness (volume) of the alignment film is, the smaller the residual DC. Conversely, it is necessary for the alignment film to maintain a certain degree of a film thickness, for example, 60 nm or more so as to prevent application defects in an alignment film printing process during panel manufacturing. Therefore, as means for solving this, methods called a modification treatment, two-layer treatment, and hybridization may be exemplified. That is, when the varnish, which is obtained by uniformly mixing the polymer of the vertical alignment film and the polymer of the horizontal alignment film, or the fluorine introduced polymer that is a vertical alignment film and the fluorine not-introduced polymer that is a horizontal alignment film in a constant ratio (for example, 30:70 to 5:95, and more preferably 25:75 to 10:90), is applied to the substrate, a phase separation occurs between the polymers immediately after the application or in a baking process after application of the alignment film. In addition, due to this operation, the horizontal alignment film is formed on a substrate side, and the vertical alignment film is formed on a liquid crystal layer side. Therefore, a volume of the alignment film that is exposed toward the liquid crystal layer side may be reduced, and this the residual DC and image-sticking caused by the residual DC may be reduced. In this embodiment, the above-described treatment may be performed as necessary. According to this, a liquid crystal display device in which the image-sticking caused by the residual DC, and image-sticking caused by an AC mode are reduced together may be realized. In addition, from the viewpoints of reliability, it is preferable that the above-described modification rate exceed 70 weight % and be equal to or less than 90 weight %. In addition, when the upper limit is set to 90 weight % or less, the photo-alignment film on a surface on a liquid crystal layer side may be allowed to function sufficiently as a photo-alignment film.

As examples of the diamine for modification treatment that is used in Embodiment 1, compounds that are shown in the following formulae (6-1) to (6-6) are preferably exemplified. In addition, an alphabet written together with a formula number is an abbreviation of each compound.

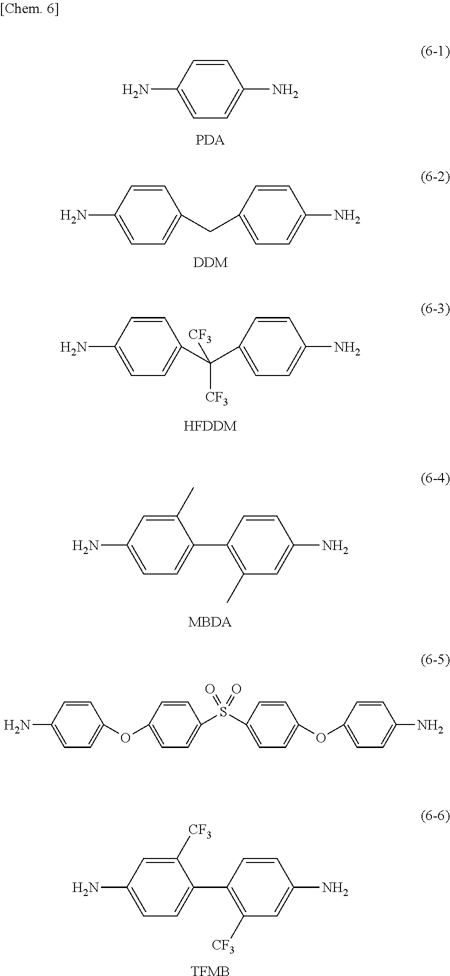

In addition, an example of the acid dianhydride for modification treatment, the above-described example of the acid dianhydride may be exemplified.

Furthermore, in a case where the photo-alignment film material is necessary, when another diamine of the composition of the copolymer is changed without changing the photo-alignment diamine, photopolymers having similar material properties and electro-optical properties may be prepared. Accordingly, reliable supply and use of a necessary material become possible by blending these photopolymers.

(Photopolymer of this Embodiment)

For example, a copolymer is formed by a technology known in the related using 4-(4,4,4-trifluorobutoxy)benzoic acid 4-{2-[2-(2,4-diaminophenyl)ethoxycarbonyl]-2-(E)-vinyl}phenyl ester as photo-alignment diamine, 5α-cholestane-3β-ol-based diamine as the vertical alignment diamine, and 4,10-dioxatricyclo(6,3,1,0)dodecane-3,5,9,11-tetraone as acid dianhydride.

(Base Polymer of this Embodiment)

For example, a polymer is prepared by a technology known in the related art using MBDA as diamine, and cyclohexane tetracarboxylic acid dianhydride as the acid dianhydride.

In addition, as a compound that may be contained to improve reliability, for example, an epoxy-based compound described in Japanese Unexamined Patent Application Laid-Open No. 2008-299317 and an epoxy group-containing compound described in Japanese Patent No. 4434862 may be appropriately used.

(Process of Preparing Liquid Crystal Cell)

After being printed, the varnish of the photo-alignment film is pre-baked on a hot plate for pre-baking at 90° C. for 1 minute (the thickness of the photo-alignment film at this time is 100 nm) and is post-baked on a hot plate for post-baking at 200° C. for 60 minutes, the substrate is cooled to room temperature, and the substrate is irradiated with P-polarized UV light having an extinction rate of 10:1 in a direction inclined from the normal line by 40° at an exposure energy of 20 mJ/cm². In one substrate, a cell-thickness maintaining material, for example, micropearl (plastic beads, manufactured by Sekisui Fine Chemical Co., Ltd,) having a diameter of 3.5 μm may be dry-sprayed in a desired amount (density: 4 to 5 pieces per 100 μm²), an ink that contains the cell thickness maintaining material (fixing beads) may be inkjet-printed to a desired position, or a photo-spacer may be formed at a desired position using a photo-sensitive resin material before the formation of the photo-alignment film. In other substrate, a method of screen-printing or dispensing a sealing material, for example, struct bond XN-21S (manufactured by Mitsui Chemicals Inc.) or a photothermal sealing material (manufactured by Kyoritsu Chemical & Co., Ltd.) is preferable. With regard to liquid crystal injection, a vacuum injection method, or dropping injection method is preferable. With the vacuum injection method, as the sealing material, photo-curable adhesives (manufactured by ThreeBond Co., Ltd. and Sekisui Fine Chemical Co., Ltd.) are preferable.

(Basic Operation—Monodomain)

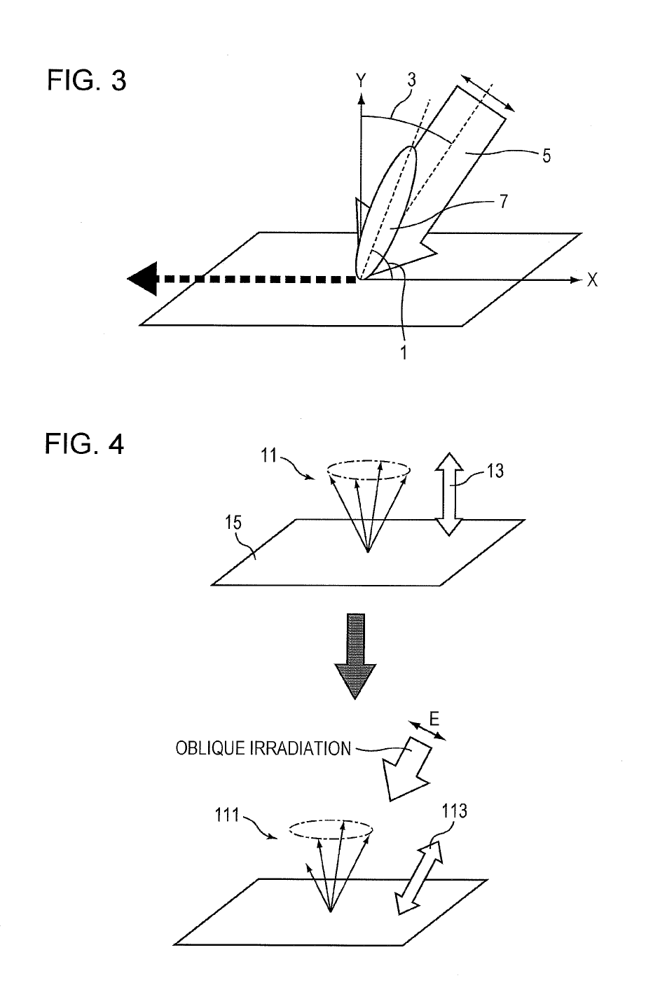

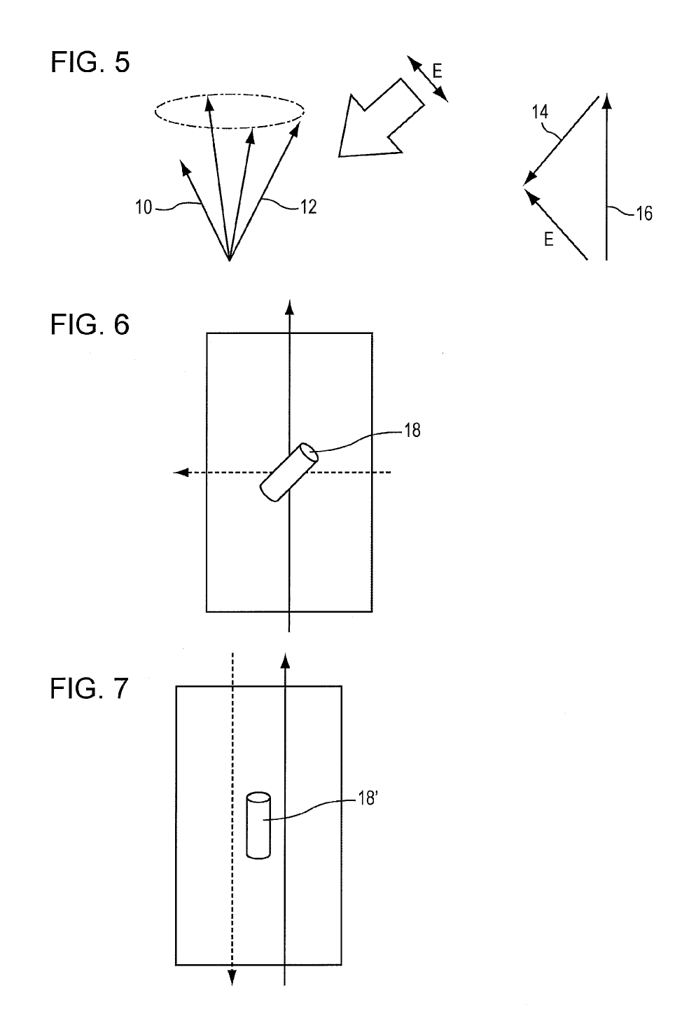

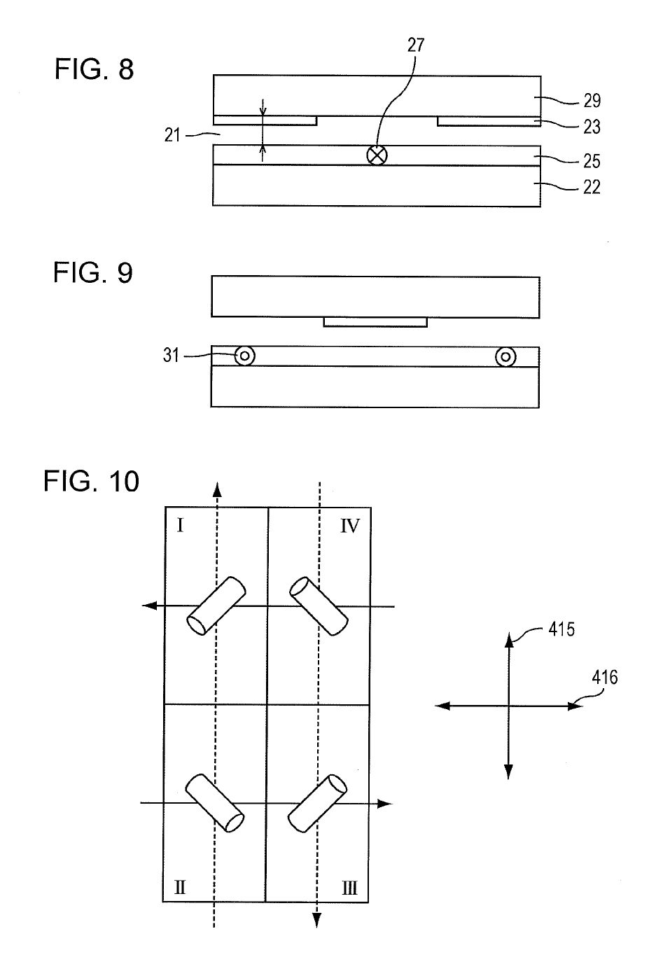

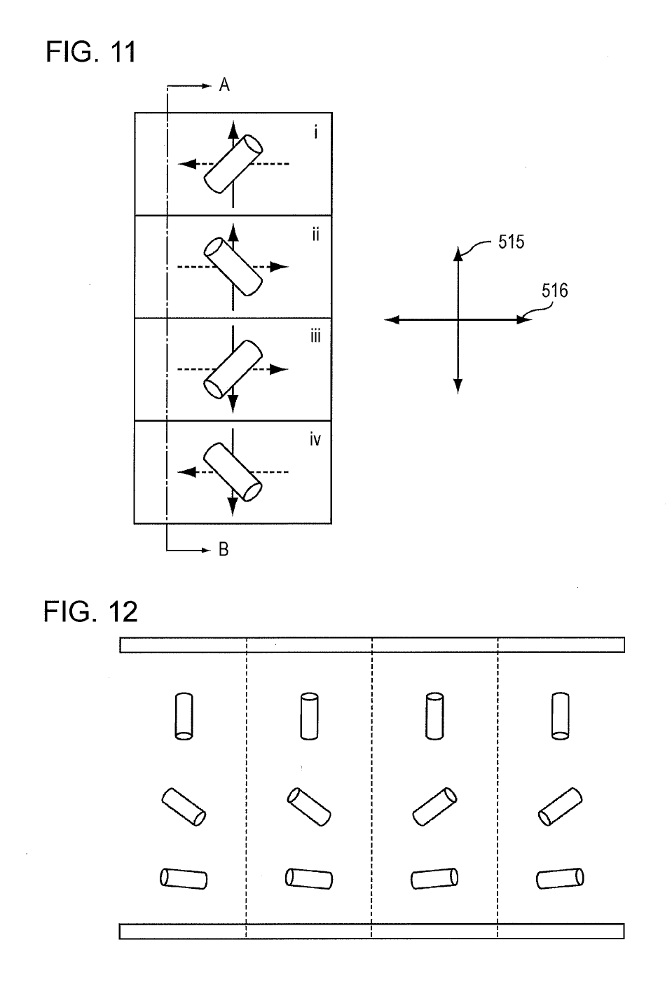

FIG. 3 shows a schematic perspective view illustrating a relationship between an UV-light alignment treatment direction and a pretilt direction of a liquid crystal molecule in Embodiment 1. FIGS. 4 and 5 show views illustrating a photo-alignment mechanism of Embodiment 1. FIGS. 6 and 7 show a case where the liquid crystal domain is a monodomain and a photo-alignment treatment is performed in directions intersecting each other in upper and lower substrates (FIG. 6) and a case where the photo-alignment treatment is performed in antiparallel directions in the upper and lower substrates (FIG. 7). That is, FIG. 6 shows a schematic plan view (VATN) illustrating a direction of a liquid crystal director in one pixel (one pixel or one sub-pixel) and a photo-alignment treatment direction with respect to a pair of substrates (upper and lower substrates) in a case where the liquid crystal display device of Embodiment 1 has a monondomain. FIG. 7 shows a schematic plan view (VAECB) illustrating a direction of the liquid crystal director in one pixel (one pixel or one sub-pixel) and a photo-alignment treatment direction with respect to a pair of substrates (upper and lower substrates) in a case where the liquid crystal display device of Embodiment 1 has a monondomain. FIGS. 8 and 9 show schematic cross-sectional views illustrating a first dispositional relationship and a second dispositional relationship between a substrate and a photomask in a divisional photo-alignment treatment process by mask alignment according to a proxy UV exposure method, respectively. In FIG. 10, a liquid crystal division pattern and a photo-alignment treatment direction of the liquid crystal display device and one pixel, and an average liquid crystal director direction during application of a voltage of 7.5 v are specified. An operation principle of the liquid crystal display device of the invention will be described with reference to FIGS. 3 to 10.

In the liquid crystal display device of the invention, a liquid crystal layer, which is formed from liquid crystal molecules having a negative dielectric anisotropy, is interposed between a pair of glass substrates. A transparent electrode is formed on surfaces of the pair of glass substrates on a side that comes into contact with the liquid crystal layer, respectively, and a photo-alignment film layer of a vertical-alignment-type is formed on the transparent electrode. As shown in FIG. 3, when irradiation of UV light polarized to be parallel with an incidence surface is performed in a direction oblique from the normal direction of the substrate, for example, by 40°, a liquid crystal pretilt angle 1 may be generated in a direction shown in FIG. 3 with respect to UV irradiation direction 5.

As shown in FIG. 6, in a case where the irradiation directions are made to intersect each other in the upper and lower substrates, a liquid crystal material not containing a chiral material is injected, and thus the liquid crystal pretilt of the upper and lower substrates become substantially the same as each other, liquid crystal molecules have a structure capable of being twisted by 90° between the upper and lower substrates during application of a voltage, but most of the liquid crystal molecules are aligned in a direction shown in FIG. 6, which divides the irradiation direction into two parts (in a direction of the average liquid crystal director direction 18 during application of an AC voltage). In addition, in FIG. 6, a solid-line arrow represents a photo-irradiation direction (one-directional photo-alignment treatment direction of the upper substrate) with respect to the upper substrate, and a dotted-line arrow represents a photo-irradiation direction (one-directional photo-alignment treatment direction of the lower substrate) with respect to the lower substrate.

(Photo-Alignment Mechanism)

For example, with regard to a photo-reaction at a cinnamate-based photo-alignment side chain, as shown in FIG. 4, in unirradiated alignment film 15, an easy axis 13 is formed in a direction that is approximately orthogonal to an alignment film plane from an unreacted side chain 11, but when oblique photo-irradiation is performed in this state, an easy axis 113 is generated. This is considered to be because a photo-sensitive side chain that is parallel with an electric vector reacts, unreacted side chain 111 remains, a rearranged side chain is generated, and thus an alignment regulation force with respect to the direction disappears. As a result, pretilt for aligning the liquid crystal is exhibited so that liquid crystal is inclined to be parallel with each other in an incidence plane of the oblique irradiation of the polarized light and to face the irradiation direction.

As described above, when assuming that the unreacted photo-alignment side chain is distributed in advance about the normal direction of the substrate, the tilt to the optical-axis direction may be explained. FIG. 5 shows a schematic view illustrating a phenomenon in which a photo-sensitive side chain 10 parallel with an electric vector E reacts, an unreacted side chain 12 remains, and a rearranged side chain is generated, and a correlation view between an alignment orientation (that is, an easy axis 14) of a structure that is generated by the above-described phenomenon), an original average side-chain distribution 16, and the electric vector E. In addition, it is ideally preferable that polarized light (P wave having the electric vector E parallel with an incidence plane) be linearly polarized light so as to efficiently cause the photo-alignment side chain for aligning liquid crystal to react with light. However, practically, the lengthening of a photo-irradiation time due to loss of illuminance is suppressed, and thus elliptically polarized light or partially polarized light is generated. With regard to generation amount of the pretilt angle, the larger the extinction rate of the polarized light becomes, the further an absolute value of (an angle from the normal line) of the pretilt decreases, that is, further inclines. For example, it is proved that polarized light having an extinction rate of 30:1 as P-wave is retarded by approximately 0.2° compared to polarized light having an extinction rate of 10:1 from a verification experiment.

As shown in FIG. 7, in a case where irradiation directions are antiparallel in the upper and lower substrates, the liquid crystal pretilt of the upper and lower substrates become substantially the same as each other, and a liquid crystal material not containing a chiral material is injected, liquid crystal molecules have a homogeneous structure in which the liquid crystal pretilt is approximately 88° in the vicinity of an interface between the liquid crystal molecules and the upper and lower substrates during application of a voltage, and are aligned in a direction (an average liquid crystal director direction 18′ during application of an AC voltage) shown in FIG. 7. In addition, in FIG. 7, a solid-line arrow represents a photo-irradiation direction (one-directional photo-alignment treatment direction of the upper substrate) with respect to the upper substrate, and a dotted-line arrow represents a photo-irradiation direction (one-directional photo-alignment treatment direction of the lower substrate) with respect to the lower substrate.

With regard to the basic operation, description has been made in detail with respect to a VA mode. However, even in TN, IPS, and ECB of a horizontal alignment type, suppression of the ACM may be expected by adapting the present technology to diamine to which a vertical alignment functional group is not introduced, diamine in which hydrophilic or horizontal alignment functional group is introduced to a side chain portion, and a diamine copolymer having a photo-alignment functional group of a horizontal alignment type. That is, it is possible to expect adaption to a horizontal alignment film constituted by a fluorine not-introduced polymer capable of causing layer separation from a photo-alignment film constituted by a fluorine-containing polymer and having horizontal alignment to occur as described.

(Divisional Alignment)

FIGS. 8 and 9 show views explaining a process of proxy UV exposure using an alignment mask (photomask 29). A width of one pixel (one pixel or sub-pixel) of the liquid crystal display device is divided into two parts, and one half is exposed in one direction (a photo-irradiation direction 27 is a depth direction from a paper plane), and the other half is shielded using a light-shielding portion 23 (FIG. 8). For example, a substrate 22 is a drive element substrate or a color filter substrate. In a subsequent step, the photomask light-shielding portion 23 is shifted by a half pitch, an exposure-termination portion is shielded, and a portion, which has been shielded, is exposed in a direction (a photo-irradiation direction 31 is a front direction from the paper plane) opposite to a direction in FIG. 8 (FIG. 9). Accordingly, the width of the one pixel (one pixel or sub-pixel) of the liquid crystal display device is divided into two parts, and thus regions having liquid crystal pretilt in directions opposite to each other are present in a strip shape. In addition, a proxy gap 21 is a gap between the photomask 29 and a photo-alignment film (vertical alignment film) 25. In addition, an exposure method may be an alignment method in which a substrate fixed and a mask is shifted, or a method in which two kinds of exposure unit groups having masks dedicated to irradiation directions of 0° and 180°, respectively, are prepared because irradiation directions of the drive element substrate and the color filter substrate are different by 180° in the same kind of substrates and are different by 90° in different kinds of substrates, and scanning exposure is performed.

Each one-side substrate is divided with an equal pitch for two-division, and both substrates are disposed in such a manner that division directions intersect each other, whereby four-division domains of I, II, III, and IV in which alignment directions of liquid crystal molecules are different in four directions are formed (FIG. 10). Since liquid crystal alignment orientation on a one-side substrate matches with a polarizing plate adsorption axis, and in the liquid crystal alignment on the one-side substrate, the liquid crystal alignment orientation is substantially orthogonal to the substrate, respective domain boundaries become dark lines during application of a voltage at polarizing plate cross-Nicole.

In addition, in FIG. 10, a dotted-line arrow represents a photo-irradiation direction (UV alignment treatment direction on a drive element side) with respect to the lower substrate (drive display element (TFT) substrate). A solid-line arrow represents a photo-irradiation direction (UV photo-alignment treatment direction on a color filter substrate side) with respect to the upper substrate (color filter substrate). A vertical arrow 415 represents an adsorption axis direction of a polarizing plate on a drive display element side, and a horizontal arrow 416 represents an adsorption axis direction of the polarizing plate on a color filter side.

FIG. 11 shows a schematic plan view illustrating a liquid crystal division pattern of one pixel, a UV photo-irradiation direction, a liquid crystal alignment direction in the liquid crystal display device of Embodiment 1. FIG. 12 shows a cross-sectional view taken along a line A-B in FIG. 11 during application of a voltage and is an alignment cross-sectional view of liquid crystal molecules.

In the liquid crystal display device of the invention, a liquid crystal layer, which is formed from liquid crystal molecules having a negative dielectric anisotropy, is interposed between a pair of glass substrates. A transparent electrode is formed on surfaces of the pair of glass substrates on a side that comes into contact with the liquid crystal layer, respectively, and a vertical alignment layer is formed on the transparent electrode.

Each one-side substrate is divided with an equal pitch for two-division, and both substrate are disposed after being shifted by a half pitch, whereby four-division domains of I, II, III, and IV in which alignment directions of liquid crystal molecules are different in four directions are formed (FIG. 11).

During not-application of a voltage, liquid crystal molecules are aligned in a direction orthogonal to the substrates by an alignment regulation force of a vertical alignment layer. As shown in FIG. 12, during application of a voltage, in the liquid crystal molecules between upper and lower substrates, four alignment states, which are different from each other in four domains twisted by approximately 90°, are present. It is considered that an average liquid crystal director in a liquid crystal cell thickness direction during application of a voltage is aligned to an approximately 45° direction between photo-alignment treatment directions, which intersect each other, of the upper and lower substrates.

In addition, in FIG. 11, a dotted-line arrow represents a photo-irradiation direction (bidirectional alignment treatment direction on a drive display element side) with respect to the lower substrate (drive display element (TFT) substrate). A solid-line arrow represents a photo-irradiation direction (bidirectional photo-alignment treatment direction on a color filter side) with respect to the upper substrate (color filter substrate). A vertical arrow 515 represents an adsorption axis direction of a polarizing plate on a drive display element side, and a horizontal arrow 516 represents an adsorption axis direction of the polarizing plate on a color filter side. In addition, in FIG. 12, a dotted-line represents a domain boundary.

In addition, if necessary, the substrate is heated to a predetermined temperature after ink is dried for fixation of PB. After the cell-thickness maintaining material is formed, the UV alignment treatment of FIG. 3 or FIGS. 8 and 9 is performed.

(Analysis of a Pretilt Permissible Range by Evaluation Of Dray Scale Deviation)

Correction is performed with respect to the liquid crystal panel to have the same properties as CRT in order for the liquid crystal panel to compatibility with a CRT. That is, as is generally known, gamma properties of the liquid crystal panel are in the vicinity of γ=2.2. It is necessary for gray scale brightness properties of an actual liquid crystal module machine (including a drive circuit) is necessary to be within a range of γ=2.2±0.2 on an image display aspect.

In a case of developing a new alignment film material, when the range of the gray scale brightness properties that are permissible for the alignment film material is set to γ=2.2±0.1, a permissible deviation amount of gray scale is ±4 gray scales. To examine a required permissible range of a pretilt angle, voltage transmittance properties of liquid crystal cells having pretilt different by 88° to 89° are converted to gray scale transmittance properties so as to evaluate the deviation amount of gray scale. As a result thereof, it is determined that the permissible range is 88.6°±0.3°. This pretilt is generated using an irradiation device of P-polarized light having an extinction rate of 10:1. It is considered that an absolute value of the pretilt decreases when the extinction rate is high, but ±relative range of the pretilt does not vary.

I. Measurement of Voltage vs Transmission Intensity of Liquid Crystal Cell

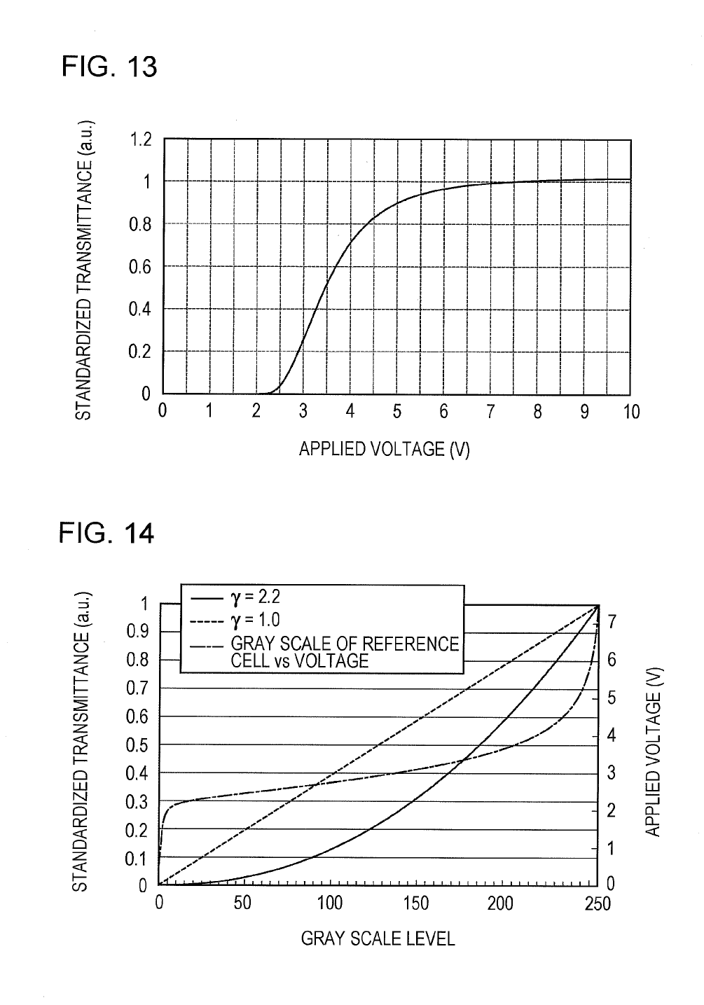

FIG. 13 shows a graph illustrating standardized transmittance against a voltage in a pretilt permissible range analysis. a.u. represents Arbitrary Unit.

(1) A voltage of 0 to 10 V is applied to respective cells having different pretilt to measure transmitted light at each voltage value. Voltage vs intensity of transmitted light is plotted.

(2) Standardization of Intensity of Transmitted Light (Transmittance)

Intensity when an applied voltage is 0.5 V is standardized to 0, and intensity when the applied voltage is 7.5 V is standardized to 1 (VT curve).

Experimental conditions are as follows.
LC (Name of a liquid crystal material): Liquid crystal A
PI (Name of an alignment film): Photo-alignment film A (an introduction ratio of a second constituent unit is 4 mol %, and a modification rate is 70 weight %)
Various irradiation conditions

(An amount of energy of UV irradiation is adjusted within a range of 10 to 100 mJ/cm² for variation of the pretilt)

Reference evaluation cell:
Pretilt: 88.6°
Cell thickness: 3.4 μm

II. Conversion to Gray Scale (0 to 255) vs Transmittance Properties

FIG. 14 shows a graph illustrating standardized transmittance (a.u.) against each gray scale (gray scale level).

Display properties (gray scale transmittance properties) of liquid crystal are corrected to γ=2.2 so as to obtain gray scale vs brightness properties of CRT.

The gray scale transmittance (brightness) properties are visually observed by human's eye in a directly proportional relationship through correction to γ=2.2 and are not visually recognized at γ=1.

A gray scale transmittance curve of γ=2.2 is expressed by transmittance=(gray scale)^{2.2}/255^{2.2}.

(3) Setting of Gray Scale Voltage of Reference

### Evaluation Cell

Transmittance of 0.5 V is set to 0 gray scale, transmittance of 7.5 V is set to 255 gray scales, and gray scale voltage (V gray scale) corresponding to each gray scale is set (calculated by measurement voltage two-point interpolation) from transmittance data of a VT curve of a cell (pretilt: 88.6° and cell thickness: 3.4 μm) that is set as a reference.

(4) Calculation of Gray Scale Transmittance (T Gray Scale) of Cell

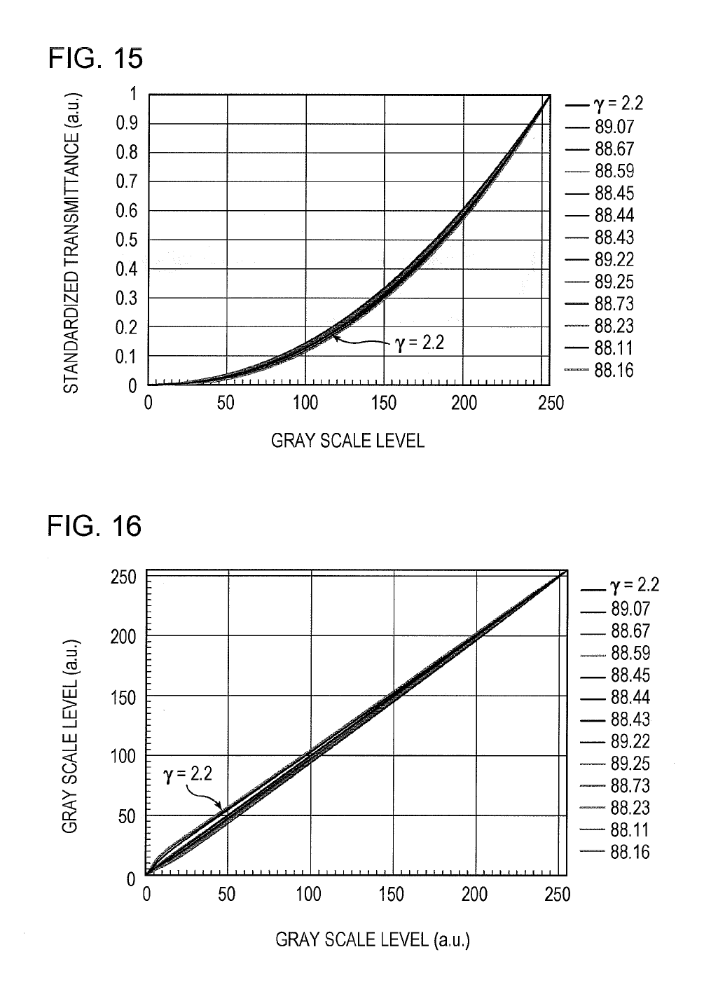

FIG. 15 shows a graph illustrating the standardized transmittance (a.u.) against each gray scale (gray scale level). FIG. 16 shows a graph illustrating each gray scale (gray scale level (a.u.)) against each gray scale (gray scale level (a.u.)) of a reference evaluation cell.

With regard to each reference gray scale voltage, each gray scale transmittance (T gray scale) is analyzed (two-point interpolation of measured transmittance) from VT curve data of a cell that is an evaluation target.

(5) Calculation of Actual Gray Scale Value at Reference Gray Scale (γ=2.2)

Actual gray scale that is the same as each gray scale transmittance of the gray scale transmittance curve of γ=2.2 is calculated (two-point interpolation) from gray scale transmittance curve data of a cell that is an evaluation target.

(6) Evaluation of Gray Scale Deviation

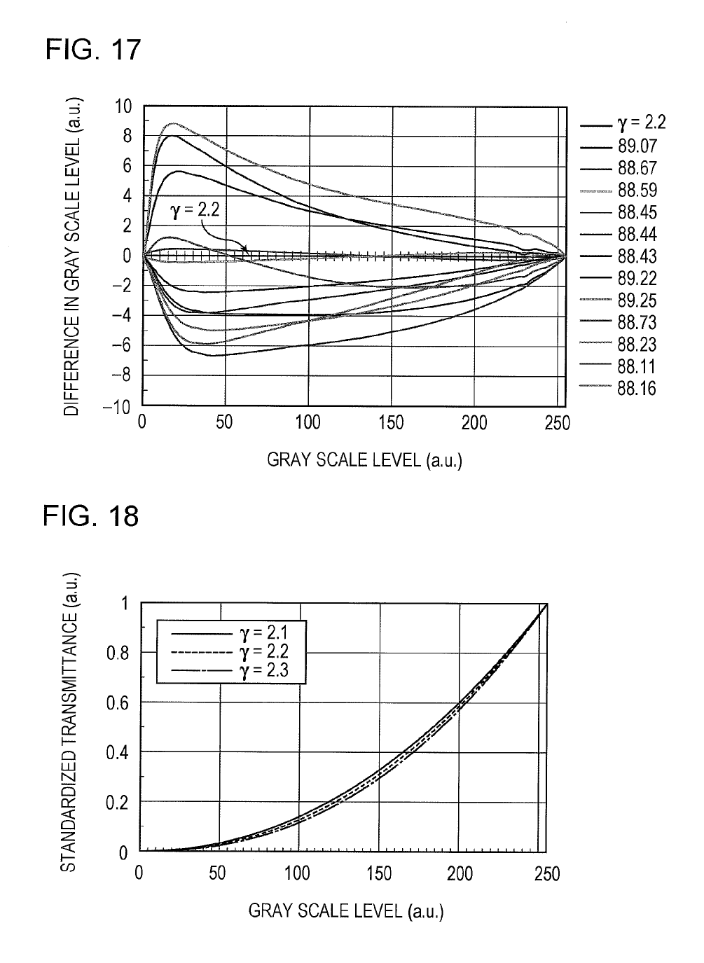

FIG. 17 shows a graph illustrating a difference in gray scale level (a.u.) against the gray scale level (a.u.) of the reference evaluation cell.

At 100 gray scales or less, maximum deviation (difference) between the reference gray scale of γ=2.2 and the real gray scale of the cell that is the evaluation target is calculated.

III. With Regard to Permissible Value of Gray Scale Deviation

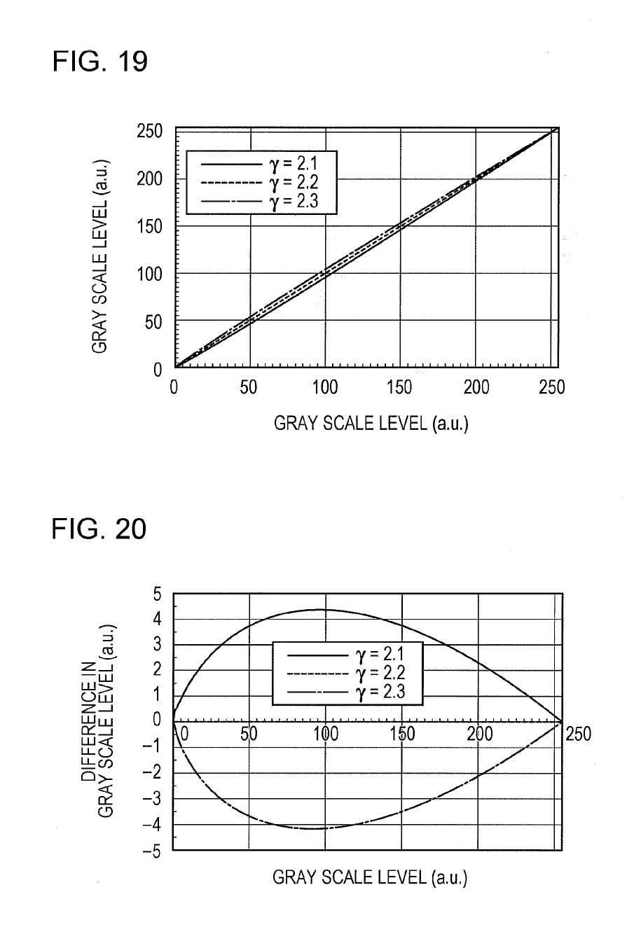

FIG. 18 shows a graph illustrating the standardized transmittance (a.u.) against the gray scale level (a.u.). The actual gray scale that is the same as each gray scale transmittance of the gray scale transmittance curve of γ=2.2 is calculated (two-point interpolation). FIG. 19 shows a graph illustrating an actual gray scale level (a.u.) at γ=2.2 against the gray scale level (a.u.). FIG. 20 shows a graph illustrating a difference in the gray scale level (a.u.) against the gray scale level (a.u.).

In a pretilt design of a new alignment film material, from an effect of cell gap variation and restriction of a drive circuit, deviation within maximum ±4 gray scales is set as a permissible value at 100 gray scales or less at which visibility is relatively high. Accordingly, it is proved that the permissible value of the pretilt is 88.6°±0.3°.

(Preferred Range of Pretilt Angle)

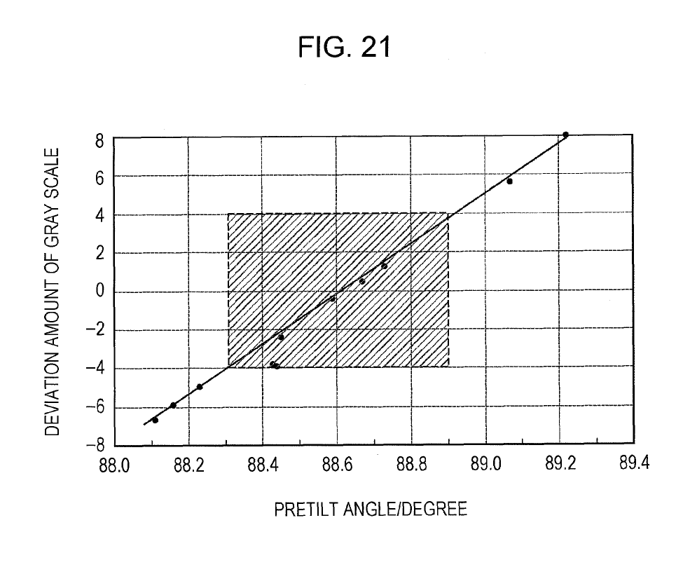

FIG. 21 shows a graph illustrating a deviation amount of the gray scale against a pretilt angle/degree. Liquid crystal display devices to which the photo-alignment treatment shown in FIG. 6 has been performed are prepared, an pretilt angle during not-application of a voltage is evaluated, a voltage-brightness property curve of the liquid crystal display devices pretilt angles different from each other is measured, each property curve is standardized in which a property curve during application of 7.5 V is set to 255 gray scales, and a property curve during application of 0.5 V is set to 0 gray scale, and a voltage-brightness properties of pretilt of 88.6° is set as γ2.2 curve. At the 100 gray scales or less, the maximum deviation amount of the gray scale is analyzed from the γ2.2 curve, and plotting is performed with respect to each pretilt angle. In addition, as a pretilt angle measuring device, OPTI-Pro manufactured by SHINTEC is used. When the deviation permissible value of gray scale and brightness properties of the liquid crystal display device is set to ±4 gray scales, as described above, a preferable range of the pretilt angle becomes 88.6°±0.3° (a hatched square area). In addition, when the deviation amount of the gray scale is set to ±2 gray scales, more preferable range is 88.6°±0.15°. In addition, when the deviation amount of the gray scale is set to ±1 gray scale, more preferable range is 88.6°±0.1°.

(Evaluation of Pretilt)

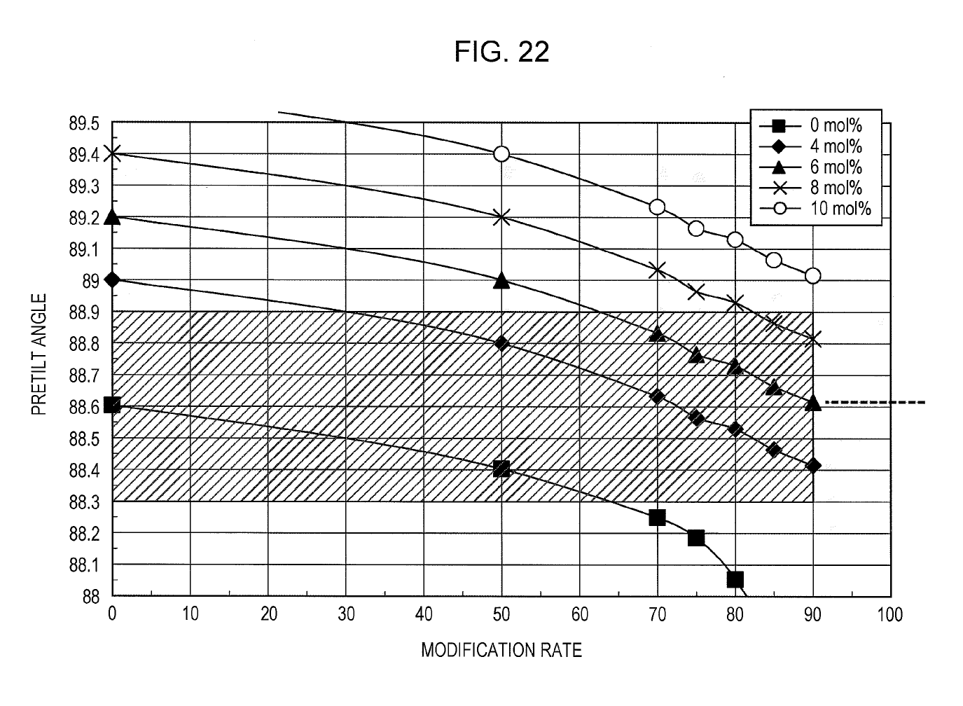

FIG. 22 shows a graph illustrating the pretilt angle/degree against a modification rate in Embodiment 1. Liquid crystal display devices to which the photo-alignment treatment shown in FIG. 6 has been performed are prepared, and with regard to pretilt angle properties during not-application of a voltage, dependency on the modification rate, and dependency on an introduction ratio (0% to 10%) of a second constituent unit of a copolymer are examined. In addition, as a pretilt angle measuring device, OPTI-Pro manufactured by SHINTEC is used.

From the viewpoint of optical properties, when a preferable range of the pretilt angle is set to 88.6°±0.3° (more preferably, 88.6°±0.15°), a hatched range is a preferable condition. That is, the preferable range of the pretilt angle may be accomplished by respective conditions, that is, a condition in which when the introduction ratio of the second constituent unit is 0 mol %, the modification rate is 0 to 63 weight %, a condition in which when the introduction ratio of the second constituent unit is 4 mol %, the modification rate is 30 to 90 weight %, a condition in which when the introduction ratio of the second constituent unit is 6 mol %, the modification rate is 63 to 90 weight %, and a condition in which when the introduction ratio of the second constituent unit is 8 mol %, the modification rate is 83 to 90 weight %. In addition, since it is preferable that the introduction ratio of the second constituent unit exceed 4 mol % from the above-described viewpoint of the quality and reliability, the preferable range of the pretilt angle may be also accomplished by a conditions in which when the introduction ratio of the second constituent unit exceeds 4 mol % and is equal to or less than 6 mol %, the modification rate is 63 to 90 weight %, and a condition in which when the introduction ratio of the second constituent unit exceeds 6 mol % and is equal to or less than 8 mol %, the modification rate is 83 to 90 weight %. When considering that a value exceeding 70 weight % is preferable as the lower limit of the modification rate for solving the above-described image-sticking, a type in which when the introduction ratio of the second constituent unit exceeds 4 mol % and is equal to or less than 6 mol %, the modification rate exceeds 70 weight % and is equal to or less than 90 weight %, and a type in which when the introduction ratio of the second constituent unit exceeds 6 mol % and is equal to or less than 8 mol %, the modification rate is 83 to 90 weight % are more preferable. Furthermore, a condition exhibiting the same value as 88.6° in a condition in which the modification rate is 70 weight % and the introduction ratio of the second constituent unit is 4 mol % is that when the introduction ratio of the second constituent unit is 6 mol %, the modification rate is 85 weight %.

(Evaluation of ACM (Evaluation of ΔTilt))

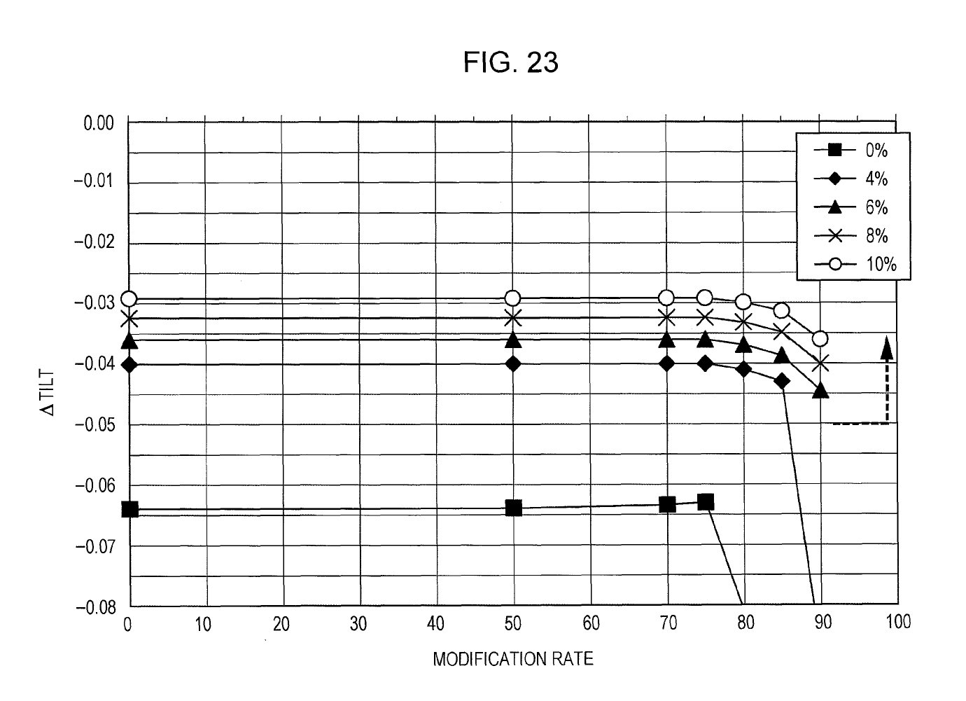

FIG. 23 shows a graph illustrating Δtilt against the modification rate in Embodiment 1. Liquid crystal display devices to which the photo-alignment treatment shown in FIG. 6 has been performed are prepared, with regard to Δtilt properties, dependency on the modification rate, and dependency on the introduction ratio (0% to 10%) of the second constituent unit of the copolymer are examined. With regard to the ACM, 7.5 V is applied with an AC voltage application stress of 30 Hz, the application of the AC voltage is set to 0 V after passage of a predetermined time, and the pretilt angle is measured. In addition, the AC voltage is applied again, the application of the AC voltage is set to OFF after passage of a predetermined time. This is repetitively performed with respect to the measurement of the pretilt angle until an accumulated AC voltage application time reaches 0 to 40 hours. Furthermore, recent five-point average value of a difference (Δtilt) between a value of the pretilt angle at early time (AC voltage application time is 0 hour) and a value of the pretilt angle for each hour after 36 to 40 hours is evaluated. In addition, Δtilt measuring device, OPTI-Pro manufactured by SHINTEC is used.

From the viewpoint of the image-sticking properties, in a case where a preferable range of the Δtilt is set to −0.05° or more, when the introduction ratio of the second constituent unit is 4 mol %, the modification rate may be accomplished up to 0 to 85 weight %, and when the introduction ratio of the second constituent unit is 6 to 10 mol %, the modification rate may be accomplished up to 0 to 90 weight %.

Furthermore, when also considering conditions of accomplishing the above-described preferable pretilt angle of 88.6°±0.3° (more preferably, 88.6°±0.15°), a condition in which when the introduction ratio of the second constituent unit is 4 mol %, the modification rate is 30 to 85 weight %, a condition in which when the introduction ratio of the second constituent unit is 6 mol %, the modification rate is 63 to 90 weight %, and a condition in which when the introduction ratio of the second constituent unit is 8 mol %, the modification rate is 83 to 90 weight % may be exemplified.

(Evaluation of VHR)

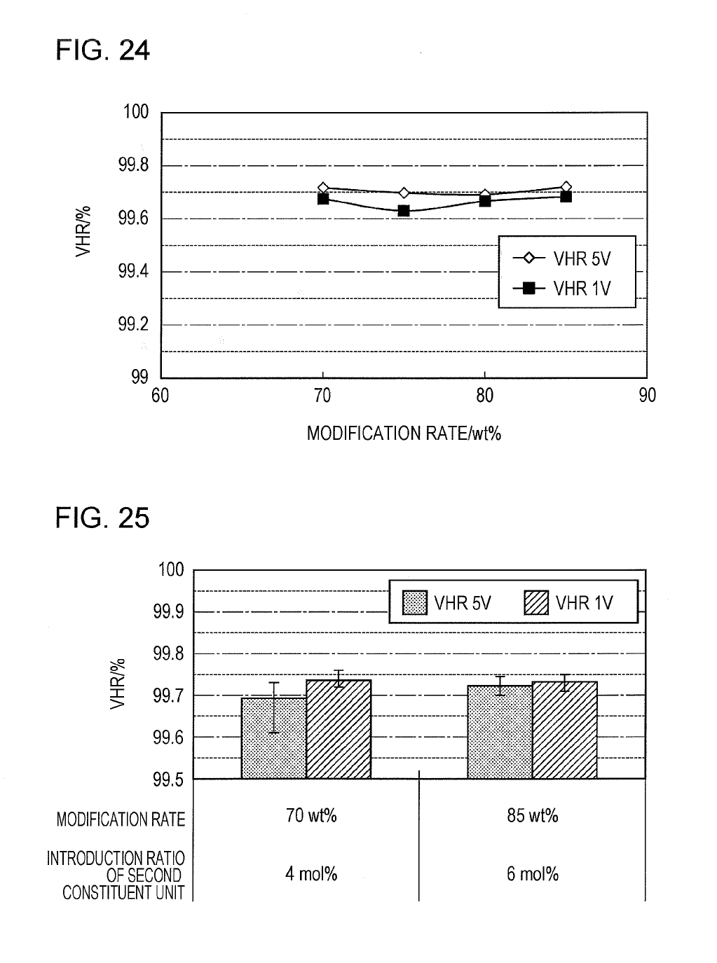

FIG. 24 shows a graph illustrating a voltage holding ratio (VHR)/% against the modification rate in Embodiment 1. Liquid crystal display devices to which the photo-alignment treatment shown in FIG. 6 has been performed are prepared, and with regard to the voltage holding ratio (VHR) properties, dependency on the modification rate, and dependency on the modification rate of 70 to 85 weight % when the introduction ratio of the second constituent unit of the copolymer is set to 4 mol % are examined. In addition, as an evaluation device, a liquid crystal properties measuring system manufactured by TOYO Corporation is used. Evaluation is performed with a pulse width of 60 μsec, a frame period of 16.7 msec, application of voltages of 5 V and 1 V, a measurement temperature of 70° C., and an area ratio. It can be seen that dependency of the voltage holding ratio (VHR) properties on the introduction ratio of the second constituent unit of the copolymer of 4 mol % and the modification rate of 70 to 85 weight % of the copolymer is not present.

FIG. 25 shows a bar graph illustrating the voltage holding ratio (VHR)/% against the modification rate and the introduction ratio of the second constituent unit in Embodiment 1. The VHR is evaluated as described above with respect to two conditions of the photo-alignment film material, that is, a condition in which the introduction ratio of the second constituent unit is 4 mol % and the modification rate is 70 weight %, and a condition in which the introduction ratio of the second constituent unit is 6 mol % and the modification rate is 85 weight %. From the evaluation, it can be seen that values of the VHR are substantially the same as each other, the dependency is not present, and thus both of these are substantially the same.

(Evaluation of Residual DC)

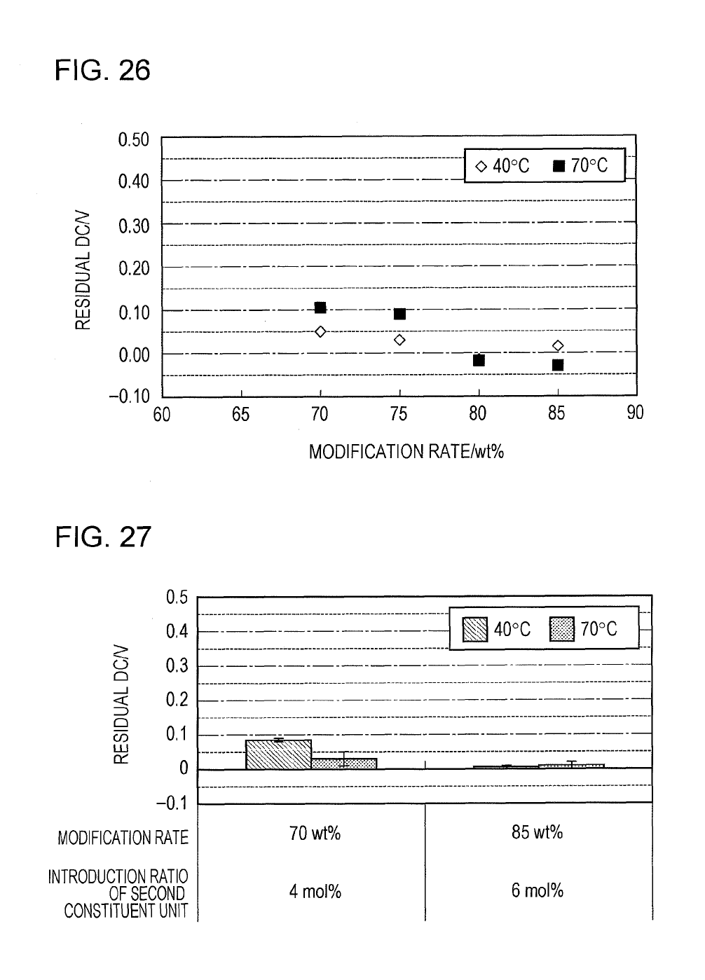

FIG. 26 shows a graph illustrating a residual DC/V against the modification rate in Embodiment 1. Liquid crystal display devices to which the photo-alignment treatment shown in FIG. 6 has been performed are prepared, and dependency on the modification rate, and dependency on the modification rate of 70 to 85 weight % when the introduction ratio of the second constituent unit of the copolymer is set to 4 mol % are examined. In addition, with regard to an evaluation order, first, a stress condition is set to AC 2.9 V (30 Hz)+DC 2.0 V, and a temperature is set to 40° C. and 70° C. Then, an erasing voltage of flicker after application of stress for 2 hours at each temperature is measured. A difference in an offset voltage before and after application of stress is set as a residual DC. From this examination, in a condition in which the introduction ratio of the second constituent unit of the copolymer is 4 mol % and the modification rate is 70 to 85 weight %, it can be seen that the dependency of the residual DC properties on this condition is substantially not present.

FIG. 27 shows a bar graph illustrating the residual DC/V against the modification rate and the introduction ratio of the second constituent unit in Embodiment 1. The residual DC is evaluated as described above with respect to two conditions of the photo-alignment film material, that is, a condition in which the introduction ratio of the second constituent unit is 4 mol % and the modification rate is 70 weight %, and a condition in which the introduction ratio of the second constituent unit is 6 mol % and the modification rate is 85 weight %. From the evaluation, it can be seen that values of the residual DC are substantially the same as each other within a measurement error.

(With Regard to Tilt Liquid Crystal Dependency)

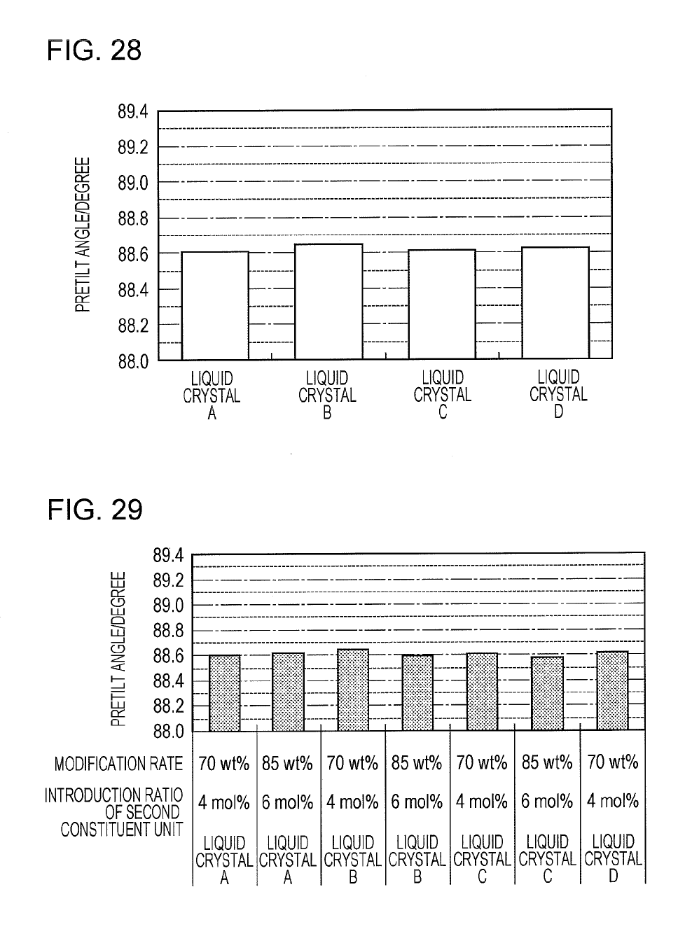

FIGS. 28 and 29 are graphs illustrating a liquid crystal dependency of the pretilt angle/degree occurred by the alignment film.

In addition, a difference (a relative value of response properties) in physical properties of liquid crystal A to D that are used is shown in Table 1, and values of an introduction ratio (mol %) of non-photo-amine to the alignment film, a modification rate (weight %), and a pretilt angle are shown in Table 2. From results of FIG. 28, it is clear that the pretilt angle of the liquid crystal substantially does not depend on a kind of the alignment film. From results of FIG. 29, it can be seen that a value of the pretilt may be made constant by adjusting a composition of the photo-alignment film. That is, it can be said that the above-described preferable ranges of the pretilt angle and Δtilt, and the like are substantially not affected by the kinds of the alignment films and the liquid crystal.

However, the present pretilt evaluation is performed in a state in which a voltage is not applied to the liquid crystal cell that is twisted by 90° between the upper and lower substrates, and as described above, the pretilt is generated using an irradiation device of 2-polarized light having an extinction rate of 10:1. It is considered that an absolute value of the pretilt decreases when the extinction rate is high, but ±relative range of the pretilt does not vary.

TABLE 1

| Abbreviation of | | Response properties |
|---|---|---|
| liquid crystal | Pretilt angle | (relative values) |
| Liquid crystal A | 88.6 | 1 |
| Liquid crystal B | 88.6 | 0.9 |
| Liquid crystal C | 88.6 | 0.96 |
| Liquid crystal D | 88.6 | 0.7 |

TABLE 2

| | Introduction | | |
|---|---|---|---|
| Abbreviation of | ratio of | Modification | Pretilt |
| liquid crystal | non-photo-amine | rate | angle |
| Liquid crystal A | 4 mol % | 70 wt % | 88.6 |
| Liquid crystal A | 6 mol % | 85 wt % | 88.6 |
| Liquid crystal B | 4 mol % | 70 wt % | 88.6 |
| Liquid crystal B | 6 mol % | 85 wt % | 88.6 |
| Liquid crystal C | 4 mol % | 70 wt % | 88.6 |
| Liquid crystal C | 6 mol % | 85 wt % | 88.6 |
| Liquid crystal D | 4 mol % | 70 wt % | 88.6 |

The respective types in the above-described embodiments may be appropriately combined within a range not departing from the gists of the invention.

The present patent application claims priority from Japanese Patent Application No. 2010-192954 filed on Aug. 30, 2010 on the basis of Paris Convention or laws and regulations of transition countries. The entire contents of application noted above are hereby incorporated by reference.

1. A liquid crystal display panel that has a configuration in which a liquid crystal layer containing liquid crystal molecules is interposed between a pair of substrates, and includes a photo-alignment film on a surface of at least one substrate on a liquid crystal layer side,
wherein in the photo-alignment film, a film formed using an alignment film material containing a polymer is subjected to an alignment treatment by photo-irradiation, the polymer including a first constituent unit exhibiting a property of controlling alignment of the liquid crystal molecules by photo-irradiation and a second constituent unit exhibiting a property of controlling alignment of the liquid crystal molecules without photo-irradiation as essential constituent units;
the first constituent unit exhibits the property of controlling alignment of the liquid crystal molecules by at least one photo-chemical reaction selected from a photo-cross-linking reaction and a photo-isomerization reaction; and
an introduction ratio of a second constituent unit exceeds 4 mol % and is equal to or less than 10 mol % on the basis of 100 mol % of a total of the first constituent unit and the second constituent unit.

2. The liquid crystal display panel according to claim 1,
wherein the introduction ratio of the second constituent unit is 8 mol % or less.

3. The liquid crystal display panel according to claim 1,
wherein the photo-alignment film includes the film formed using the alignment film material and a film formed from a material other than the alignment film material, a surface portion of the photo-alignment film on a liquid crystal layer side is essentially composed of the film formed using the alignment film material, and in a case where a ratio of a solid-content of the material other than the alignment film material to 100 weight % of a solid-content of the alignment film material and the material other than the alignment film material is set to a modification rate, the modification rate exceeds 70 weight % and is equal to or less than 90 weight %.

4. (canceled)

5. The liquid crystal display panel according to claim 1,
wherein the photo-alignment film includes the film formed using the alignment film material and a film formed using a material other than the alignment film material, and a surface portion of the photo-alignment film on a liquid crystal layer side is essentially composed of the film formed using the alignment film material, and in a case where a ratio of a solid-content of the material other than the alignment film material to 100 weight % of a solid-content of the alignment film material and the material other than the alignment film material is set to a modification rate, when the introduction ratio of the second constituent unit exceeds 4 mol % and is equal to or less than 6 mol %, the modification rate exceeds 70 weight % and is equal to or less than 90 weight %, and when the introduction ratio of the second constituent unit exceeds 6 mol % and is equal to or less than 8 mol %, the modification rate is 83 to 90 weight %.

6. (canceled)

7. The liquid crystal display panel according to claim 1,
wherein the first constituent unit of the polymer in the alignment film material has a side chain having a photo-functional group.

8. The liquid crystal display panel according to claim 1,
wherein the second constituent unit of the polymer in the alignment film material has a side chain having an alignment functional group.

9. The liquid crystal display panel according to claim 1,
wherein the essential constituent unit of the polymer in the alignment film material has the same alignment control direction.

10. (canceled)

11. The liquid crystal display panel according to claim 1,
wherein the photo-alignment film is a vertical alignment film that performs a vertical alignment control of the liquid crystal molecules.

12. The liquid crystal display panel according to claim 11,
wherein the second constituent unit of the polymer in the alignment film material has a side chain having a vertical alignment functional group.

13. The liquid crystal display panel according to claim 11,
wherein the first constituent unit of the polymer in the alignment film material has a side chain having at least one photo-functional group selected from a group consisting of a coumarin group, a cinnamate group, a chalcone group, an azobenzene group, and a stilbene group.

14. The liquid crystal display panel according to claim 11,
wherein the second constituent unit of the polymer in the alignment film material has a side chain having a steroid skeleton.

15. The liquid crystal display panel according to claim 11,
wherein the second constituent unit of the polymer in the alignment film material has a side chain having a structure in which 3 to 4 rings selected from any one of 1-4-cyclohexylene and 1,4-phenylene are linearly coupled directly or through 1,2-ethylene.

16. The liquid crystal display panel according to claim 11,
wherein the polymer in the alignment film material has a main chain structure of at least one selected from a group consisting of polyamic acid, polyimide, polyamide, and polysiloxane.

17. The liquid crystal display panel according to claim 11,
wherein the essential constituent units of the polymer in the alignment film material are formed by diamine.

18. The liquid crystal display panel according to claim 11,
wherein the polymer in the alignment film material is a copolymer of a monomer component that contains at least one of diamine, acid dianhydride, and dicarboxylic acid.

19. The liquid crystal display panel according to claim 1,
wherein with regard to the polymer in the alignment film material, the monomer component of the second constituent unit exceeds 4 mol % and is equal to or less than 10 mol % on the basis of 100 mol % of a total amount of the monomer component of the first constituent unit and the monomer component of the second constituent unit.

20. The liquid crystal display panel according to claim 1,
wherein the liquid crystal display panel includes pixels that are arranged in a matrix shape, each pixel having a pixel electrode disposed on one substrate on a liquid crystal layer side in a matrix shape, and a common electrode disposed on the other substrate on a liquid crystal layer side, and the pixel has two or more domains that are adjacently disposed.

21. A liquid crystal display panel that has a configuration in which a liquid crystal layer containing liquid crystal molecules is interposed between a pair of substrates, and includes a photo-alignment film on a surface of at least one substrate on a liquid crystal layer side,
wherein the photo-alignment film contains a polymer including a third constituent unit having a structure derived from a photo-functional group, and a fourth constituent unit that does not have the photo-functional group and the structure derived from the photo-functional group and has an alignment functional group as essential constituent units; and
an introduction ratio of the fourth constituent unit exceeds 4 mol % and is equal to or less than 10 mol % on the basis of 100 mol % of a total of the third constituent unit and the fourth constituent unit.

22. (canceled)

23. (canceled)

24. A polymer for an alignment film material, the polymer comprising:
a polymer including the first constituent unit and the second constituent unit as essential constituent units the polymer being contained in the alignment film material that forms the photo-alignment film provided to the liquid crystal display panel according to claim 1.

25. A polymer for an alignment film material, the polymer comprising:
a polymer including the third constituent unit and the fourth constituent unit as essential constituent units, the polymer being contained in the alignment film material that forms the photo-alignment film provided to the liquid crystal display panel according to claim 21.
